(19) United States
(12) Patent Application Publication
(10) Pub. No.: US 2008/0273584 A1
(43) Pub. Date: Nov. 6, 2008

(54) Generating test sequences for circuit channels exhibiting duty-cycle distortion

(76) Inventor: Vladimir Dmitriev-Zdorov, Longmont, CO (US)

Correspondence Address: KLARQUIST SPARKMAN, LLP, 121 S.W. SALMON STREET, SUITE 1600, PORTLAND, OR, 97204, US

(21) Appl. No.: 12/150,658

(22) Filed: Apr. 29, 2008

Related U.S. Application Data
(63) Continuation-in-part of application No. 11/880,354, filed on Jul. 19, 2007.
(60) Provisional application No. 60/933,807, filed on Jun. 8, 2007.
(60) Provisional application No. 60/927,163, filed on May 1, 2007.

(51) Int. Cl. H04B 17/00; H04B 3/46; H04Q 1/20

(52) U.S. Cl. 375/224

(57) ABSTRACT

Disclosed herein are exemplary methods, apparatus, and systems for generating test sequences that can be used to evaluate high-speed circuit pathways that exhibit duty-cycle distortion (e.g., clock-related duty-cycle distortion or data-dependent duty-cycle distortion). In one exemplary embodiment, a period of an input signal is divided into two or more subintervals, each subinterval having a duration that is different from other subintervals. Pulse representations are generated for each of the subintervals, the pulse representations representing pulse durations corresponding to the respective durations of each of the subintervals. Inverted sampled pulse responses are generated to the pulse representations. Samples from two or more of the inverted sampled pulse responses are combined to create one or more combined inverted sampled pulse responses. A test sequence is determined for testing the electrical behavior of a circuit channel using the one or more combined sampled pulse responses and stored on one or more computer-readable media.

### CROSS-REFERENCE TO RELATED APPLICATIONS

This application claims the benefit of U.S. Provisional Patent Application No. 60/933,807 filed Jun. 8, 2007. This application is also a continuation-in-part of U.S. patent application Ser. No. 11/880,354 filed Jul. 19, 2007, which claims the benefit of U.S. Provisional Patent Application No. 60/927,163, filed on May 1, 2007. U.S. Provisional Patent Application Nos. 60/933,807, 60/927,163 and U.S. patent application Ser. No. 11/880,354 are all hereby incorporated herein by reference.

### TECHNICAL FIELD

This application relates generally to the field of analyzing the signal integrity of signals using an electronic design automation software tool.

### BACKGROUND

Signal integrity is an important consideration in designing today's high-speed circuits and systems. To help optimize the performance of such circuits and systems, simulation-based analysis techniques that predict the signal integrity of the various circuit paths of the system are often used before the circuit is ever manufactured. In this simulation environment, signal integrity problems (caused, for example, by noise, crosstalk, or intersymbol interference) can be identified early and the design modified if necessary.

One area where simulation-based signal integrity analysis is increasingly used is in the design of printed circuit boards (“PCBs”). When designing PCB layouts, for example, it is often desirable to analyze the signal integrity of the channels between the integrated circuits (“ICs”) on the board or between various other circuit components of the PCB. In particular, the signal integrity of a channel between a driver and a buffer of a PCB layout is desirably analyzed so that the bit error rate (“BER”) and eye diagram for the channel can be accurately predicted and analyzed before the PCB is manufactured. Accordingly, improved methods for analyzing the signal integrity of channels in a PCB layout or integrated circuit design are desired.

### SUMMARY

Disclosed herein are exemplary methods, apparatus, and systems for generating test sequences that can be used to evaluate high-speed circuit pathways. The disclosed methods, apparatus, and systems can be used, for example, in a printed circuit board or integrated circuit design flow to analyze signal integrity or other electrical behavior. The disclosed methods, apparatus, and systems should not be construed as limiting in any way. Instead, the present disclosure is directed toward all novel and nonobvious features and aspects of the various disclosed methods, apparatus, systems, and equivalents thereof, alone and in various combinations and subcombinations with one another. The present disclosure is not limited to any specific aspect or feature, or combination thereof, nor do the disclosed methods, apparatus, and systems require that any one or more specific advantages be present or problems be solved.

Among the disclosed embodiments are methods for generating a test sequence of bits that can be used, for example, to test the electrical behavior of a circuit channel. For example, in certain embodiments disclosed herein, a period of an input signal is divided into two or more subintervals, each subinterval having a duration that is different from other subintervals. Pulse representations are generated for each of the subintervals, the pulse representations representing pulse durations corresponding to the respective durations of each of the subintervals. Sampled pulse responses (e.g., inverted sampled pulse responses) are generated to the pulse representations. Samples from two or more of the sampled pulse responses are combined to create one or more combined sampled pulse responses (e.g., combined inverted sampled pulse responses). A test sequence is determined for testing the electrical behavior of a circuit channel using the one or more combined sampled pulse responses. The test sequence can be stored on one or more computer-readable media. In particular embodiments, the combined sampled pulse responses comprise sample values alternatingly selected from the sampled pulse responses. In some embodiments, the period of the input signal is divided into a first subinterval and a second subinterval, the first subinterval corresponding to even bits in the input signal and the second subinterval corresponding to odd bits in the input signal. In these embodiments, the sampled pulse responses can comprise a first sampled pulse response corresponding to the even bits in the input signal and a second sampled pulse response corresponding to the odd bits in the input signal. Furthermore, the one or more combined sampled pulse responses can comprise a first combined sampled pulse response and a second combined sampled pulse response, the first combined sampled pulse response comprising alternating samples from the first and the second sampled pulse responses and having a largest sample value selected from the first sampled pulse response, the second combined sampled pulse response comprising alternating samples from the first and the second sampled pulse responses and having a largest sample value from the second sampled pulse response. In certain embodiments, two or more combined sampled pulse responses are generated and the act of determining a test sequence comprises determining a candidate test sequence for each of the two or more combined sampled pulse responses, and selecting the test sequence from among the candidate test sequences, the test sequence selected being the test sequence that creates the smallest eye opening in an eye diagram. In some embodiments, the differences in the durations of the two or more subintervals are a result of duty cycle distortion. In certain embodiments, the test sequence generated complies with a transmission code (e.g., the 8b10b code). Further, in some embodiments, for each respective one of the one or more combined sampled pulse responses, the respective combined sampled pulse response is divided into a series of bit groups in which the respective lengths of the bit groups in the series comply with a transmission code; possible code word types corresponding to the bit groups of the respective combined sampled pulse response and also complying with the transmission code are determined; the cumulative costs for one or more of the possible code word types are computed, wherein the cumulative cost for a respective code word type can indicate how effective a sequence comprising a code word of the respective code word type together with one or more other code words is at altering the intended output of a circuit channel when the sequence is included in the test sequence; and the test sequence is generated by selecting a sequence of code words based at least in part on the determined cumulative costs. Local costs can also be computed for the one or more of the possible code word types, wherein the local cost for a respective code word type indicates how effective a code word of the respective code word type is at altering an intended output of the circuit channel when the code word is included in the test sequence.

In other exemplary embodiments, an asymmetrical input pulse is decomposed into a symmetrical component and an asymmetrical component. A first sampled pulse response to the symmetrical component is generated. A second sampled pulse response to the asymmetrical component is also generated. A test sequence for testing the electrical behavior of a circuit channel is determined using the first sampled pulse response and the second sampled pulse response. The test sequence can be stored on one or more computer-readable media. The symmetrical component can be linear and time invariant, and the asymmetrical component can be not linear and time invariant. In particular embodiments, the test sequence generated complies with a transmission code (e.g., the 8b10b transmission code). In some embodiments, the first sampled pulse response and the second sampled pulse response are inverted sampled pulse responses. In certain embodiments, the act of generating the first sampled pulse response and the second sampled pulse response comprises simulating application of the symmetrical component to a circuit channel, thereby generating a first pulse response; dividing the first pulse response into first pulse samples, thereby generating the first sampled pulse response; simulating application of the asymmetrical component to the circuit channel, thereby generating a second pulse response; and dividing the second pulse response into second pulse samples, thereby generating the second sampled pulse response. The first pulse samples and the second pulse samples can be determined according to the bit rate at which the circuit channel is to operate. In particular embodiments, the test sequence generated can be one that minimizes an eye opening of an eye diagram that displays a representation of the circuit channel's response to the test sequence.

In further disclosed embodiments, an asymmetrical input pulse is decomposed into a symmetrical component and an asymmetrical component. A first sampled pulse response to the symmetrical component is generated. A second sampled pulse response to the asymmetrical component is also generated. The first sampled pulse response and the second sampled pulse response are divided into a series of bit positions. Bit types that can be included at each of the bit positions are determined. Cumulative costs for one or more of the bit types at a respective bit position are computed using both the first sampled pulse response and the second sampled pulse response (the cumulative cost for a respective bit type can indicate how effective a series of bits comprising the respective bit type together with one or more bit types at other bit positions is at altering the intended output of a circuit channel). A test sequence can be determined by selecting bit types for each of the bit positions based at least in part on the computed cumulative costs. In some embodiments, the act of determining the test sequence further comprises computing local costs for the one or more of the bit types at the respective bit position (the local cost for a respective bit type can indicate how effective the respective bit type is at altering the intended output of the circuit channel). Furthermore, the local cost for a respective bit type can be based at least in part on the value of the first sampled pulse response at the respective bit position and the value of the second sampled pulse response at the respective bit position. In certain embodiments, the act of computing the cumulative costs comprises computing cumulative costs of series of bits that represent full test sequences, and the act of generating the test sequence comprises selecting the series of bits with the lowest cumulative cost or selecting the series of bits with the highest cumulative cost. In some embodiments, the cumulative cost for the respective bit type at the respective bit position is based at least in part on a cumulative cost of a bit type at a preceding bit position, the bit type at the preceding position being one of multiple permissible bit types at the preceding bit position. The bit type at the preceding bit position can have the lowest cumulative cost of the multiple permissible bit types at the preceding bit position or the highest cumulative cost of the multiple permissible bit types at the preceding bit position.

In other disclosed embodiments, an asymmetrical input pulse is decomposed into a symmetrical component and an asymmetrical component. A first sampled pulse response to the symmetrical component is generated. A second sampled pulse response to the asymmetrical component is also generated. The first sampled pulse response and the second sampled pulse response are divided into a series of bit groups, the respective lengths of the bit groups complying with a transmission code (e.g., the 8b10b transmission code). Group types that can be used for each of the bit groups are determined, the group types also complying with the transmission code. Cumulative costs for one or more of the group types for a respective bit group are computed using both the first sampled pulse response and the second sampled pulse response (the cumulative cost for a respective group type can indicate how effective a series of bits comprising a code word of the respective group type together with one or more other code words from other bit groups is at altering an intended output of a circuit channel). The test sequence can be generated by selecting code words and group types for each bit group based at least in part on the computed cumulative costs. In particular embodiments, the act of determining the test sequence further comprises computing local costs for the one or more of the group types for the respective bit group (the local cost for a respective group type can indicate how effective a code word of the respective group type is at altering the intended output of the circuit channel). Furthermore, the act of computing the local costs can comprise evaluating possible code words of a respective group type to determine which of the possible code words produces the lowest local cost or the highest local cost for that respective group type. In some embodiments, the local cost for a respective group type is based at least in part on the values of the first sampled pulse response corresponding to the respective bit group and the values of the second sampled pulse response corresponding to the respective bit group. The local cost for the respective group type can depend in part on whether a transition exists at the beginning or end of the respective group type. In some embodiments, the act of computing the cumulative costs comprises computing cumulative costs of series of bits that represent full test sequences, and the act of generating the test sequence comprises selecting the series of bits with the lowest cumulative cost or the series of bits with the highest cumulative cost. The cumulative cost for a respective group type for the respective bit group can be based at least in part on a cumulative cost of a group type for a preceding bit group, the group type for the preceding bit group being one of multiple permissible group types at the preceding bit group. Further, the group type at the preceding bit position can have a code word resulting in the lowest cumulative cost of the multiple permissible group types at the preceding bit position or resulting in the highest cumulative cost of the multiple permissible bit types at the preceding bit position. In some embodiments, the act of dividing includes orienting the bit groups in a first orientation relative to a leading bit in the first and second sampled pulse response, and the acts of dividing, determining, and computing can be repeated for one or more other bit group orientations relative to the leading bit.

Any of the disclosed methods can be implemented by a computer. Further, any of the disclosed methods can be implemented as computer-readable media comprising computer-executable instructions for causing a computer to perform the methods. Any of the disclosed methods implemented in a computer environment can also be performed by a single computer or via a network. Further, computer-readable media storing test sequences or test sequence values (or any other final or intermediate results) produced by any of the disclosed methods are also disclosed.

The foregoing and other objects, features, and advantages of the invention will become more apparent from the following detailed description, which proceeds with reference to the accompanying figures.

### BRIEF DESCRIPTION OF THE DRAWINGS

FIG. 1 is a graph showing an exemplary pulse response of a signal channel under consideration.

FIG. 2 is a graph showing an exemplary sampled pulse response generated from the pulse response of FIG. 1.

FIG. 3 is a graph showing an exemplary inverted sampled pulse response generated from the sampled pulse response of FIG. 2.

FIG. 4 is a schematic block diagram showing code word types and allowed transitions between the code word types according to an exemplary transmission code.

FIG. 5 is an exemplary representation showing an arrangement of possible code word types relative to bit groups in a sampled pulse response as may be used to generate a test sequence using embodiments of the disclosed technology.

FIG. 6 illustrates the use of a representation according to FIG. 5 as part of an exemplary test sequence generation procedure. In particular, FIG. 6 illustrates the process of determining local costs of code word types according to an exemplary embodiment of the disclosed technology.

FIG. 7 also illustrates the use of a representation according to FIG. 5 as part of an exemplary test sequence generation procedure. In particular, FIG. 7 illustrates the process of determining cumulative costs of code word types according to an exemplary embodiment of the disclosed technology.

FIG. 8 is a schematic block diagram of a distributed computer network that can be used to perform any of the disclosed methods.

FIG. 9 is a schematic block diagram of another distributed computer network that can be used to perform any of the disclosed methods.

FIG. 10 is a flowchart showing an exemplary application of the computer networks of FIG. 8 or FIG. 9.

FIG. 11 is a flowchart of a first exemplary embodiment for generating test sequences.

FIG. 12 is a flowchart of a second exemplary embodiment for generating test sequences.

FIG. 13 is a graph of two exemplary waveforms illustrating clock-related duty-cycle distortion.

FIG. 14 is a graph showing exemplary even-bit and odd-bit elementary functions derived from the graph in FIG. 13.

FIG. 15 comprises graphs illustrating exemplary even-bit and odd-bit pulse responses to the elementary functions shown in FIG. 14.

FIG. 16 comprises graphs illustrating exemplary even-bit and odd-bit sampled pulse responses to the elementary functions shown in FIG. 14.

FIG. 17 comprises graphs illustrating exemplary even-bit and odd-bit inverted sampled pulse responses to the elementary functions shown in FIG. 14.

FIG. 18 comprises graphs illustrating exemplary combined inverted sampled pulse responses generated from the inverted sampled pulse responses shown in FIG. 17.

FIG. 19 is a graph showing an exemplary input signal exhibiting data-dependent duty-cycle distortion.

FIG. 20 is a graph illustrating aspects of data-dependent duty-cycle distortion.

FIG. 21 is a chart showing the “symmetric” component of the waveform illustrated in FIG. 19 along with its “asymmetric” addition.

FIG. 22 comprises timing charts illustrating an exemplary symmetric pulse and asymmetric addition and their respective pulse responses.

FIG. 23 comprises graphs illustrating exemplary inverted sampled pulse responses to the pulses shown in FIG. 22.

FIG. 24 is a schematic block diagram showing bit types and allowed transitions between the bit types.

FIG. 25 illustrates the use of a representation as in FIG. 24 as part of an exemplary test sequence generation procedure. In particular, FIG. 25 illustrates the process of determining cumulative costs of bit types according to an exemplary embodiment of the disclosed technology and using an exemplary cost table.

FIG. 26 is a schematic block diagram showing bit groups and allowed transitions between the bit groups according to a transmission code.

FIG. 27 is a flowchart of a third exemplary embodiment for generating test sequences.

FIG. 28 is a flowchart of a fourth exemplary embodiment for generating test sequences.

FIG. 29 is a flowchart of a fifth exemplary embodiment for generating test sequences.

FIG. 30 is a flowchart of a sixth exemplary embodiment for generating test sequences.

### DETAILED DESCRIPTION

### I. Generation Considerations

Disclosed herein are exemplary methods, apparatus, and systems for modeling and evaluating high-speed signals that can be used, for example, in a printed circuit board (“PCB”) or integrated circuit (“IC”) design flow to analyze signal integrity. The disclosed methods, apparatus, and systems should not be construed as limiting in any way. Instead, the present disclosure is directed toward all novel and nonobvious features and aspects of the various disclosed methods, apparatus, systems, and equivalents thereof, alone and in various combinations and subcombinations with one another. The present disclosure is not limited to any specific aspect or feature, or combination thereof, nor do the disclosed methods, apparatus, and systems require that any one or more specific advantages be present or problems be solved.

Although the operations of some of the disclosed methods, apparatus, and systems are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the figures may not show the various ways in which the disclosed methods, apparatus, and systems can be used in conjunction with other methods, apparatus, and systems. Additionally, the description sometimes uses terms like “generate” and “determine” to describe the disclosed methods. These terms are high-level abstractions of the actual operations that are performed. The actual operations that correspond to these terms may vary depending on the particular implementation and are readily discernible by one of ordinary skill in the art.

The disclosed embodiments can be used to generate test pattern sequences for testing and evaluating the signal integrity on channels (e.g., traces, vias and/or other forms of interconnect between a driver and a receiver) in a PCB layout. For example, the sequences generated can produce the worst or near worst eye openings on an eye diagram (often used to provide a visual display of the signal quality on a channel being analyzed over many transitions). The disclosed technology is not limited to PCB layout analysis, however, and can be used to evaluate interconnects, vias, and other wires in a wide variety of circuits (e.g., application-specific integrated circuits (“ASICs”) (including mixed-signal ASICs), systems-on-a-chip (“SoCs”), or programmable logic devices (“PLDs”), such as field programmable gate arrays (“FPGAs”)). The techniques can also be used to create sequences used to evaluate power-integrity effects on a channel.

Any of the methods or techniques described herein can be performed using software that comprises computer-executable instructions for causing a computer to perform the methods or techniques stored on one or more computer-readable media. Such software can comprise, for example, an electronic-design-automation (“EDA”) software tool, such as a signal integrity tool. The Hyperlynx tool available from Mentor Graphics Corporation is one example of a suitable software tool. Any such software can be executed on a single computer or on a networked computer system (e.g., via the Internet, a wide-area network, a local-area network, a client-server network, or other such network). For clarity, only certain selected aspects of the software-based implementations are described. Other details that are well known in the art are omitted. For example, it should be understood that the disclosed technology is not limited to any specific computer language, program, or computer and that the disclosed technology can be implemented using any commercially available computer. Because such computer hardware is well known in the art, the computer hardware is not described in further detail.

One or more test sequences or intermediate results produced by any of the disclosed methods, apparatus, and systems can also be stored on one or more computer-readable media as part of the described methods and techniques and are considered to be within the scope of this disclosure. Computer-readable media storing such test sequences or intermediate results may be accessed and used by a single computer or a networked computer. Furthermore, such test sequences or intermediate information can be accessed through a variety of communication means, including for example the Internet, the World Wide Web, an intranet, software applications, cable, magnetic, electronic communications, or other communications means.

Any of the disclosed methods can also be used to generate test sequences for use in a computer simulation environment wherein the test sequences are applied to representations of circuits which are stored on one or more computer-readable media. For example, the disclosed methods typically use circuit design information (e.g., PCB layout information (such as a .HYP file), device models (such as IBIS models), netlists, GDSII descriptions, or HDL descriptions (such as a Verilog or VHDL descriptions), or the like) stored on computer-readable media. In certain embodiments, the circuits to be simulated are instantiated as SPICE or Eldo models for simulation. For presentation purposes, the present disclosure sometimes refers to circuit components by their physical counterparts (e.g., drivers, channels, signals, and other such terms). It should be understood, however, that any such reference not only includes the physical components but also representations of such circuit components and signals on the components as are used in computer-implemented signal integrity analysis environments.

Described below are representative embodiments for generating test sequences for testing electrical behavior (e.g., the signal integrity) of channels between drivers and receivers in a PCB layout. The resulting test sequences can be used, for example, in a simulation tool used to analyze the signal integrity of channels in a PCB layout. As noted, the described methods can be used to generate sequences for other circuit environments as well. In general, the test sequences desirably represent the “worst-case” scenario for bit sequences on the channel. It is to be understood that the term “worst case” does not necessarily refer to the absolute worst case, but encompasses test sequences that cause the output level (voltage) of the channel to be altered from its ideal output level by other amounts (e.g., within 5% of its worst possible performance, 10% of its worst possible performance, or other desired figure).

Furthermore, certain implementations of the described embodiments generate test sequences in a nonrandom fashion. For example, some of the implementations of the disclosed embodiments generate test sequence by evaluating possible code words to include in a test sequence according to certain criterion or figures of merit that indicate the desirability of including respective code words in the test sequence.

Furthermore, the described embodiments can be used to generate sequences for circuits designed to operate according to a certain transmission code (also referred to as a line code). For illustrative purposes, the embodiments are described in the context of the 8b10b transmission code, though it is to be understood that the methods can be readily adapted for use with other transmission codes. 8b10b transmission codes are discussed in more detail in Widmer A. X., Franaszek P. A., “A DC-Balanced, partitioned-block, 8b/10b transmission code,” IBM J. Res. Development, Vol. 27, No 5, September 1983, pp. 440-451.

II. Generating Test Sequences for Channels with No Duty-Cycle Distortion

### A. FIRST ILLUSTRATIVE EMBODIMENT

In certain implementations of the first illustrative embodiment, the method for generating a test sequence uses the inverted sampled pulse response (Q(k), k=1 . . . N) of the channel under consideration. The inverted sampled pulse sequence can be obtained, for example, by performing a circuit simulation of the channel (e.g., using analytical models of the channel, SPICE models, IBIS models, transistor-level models, ideal voltage source models, or other such models). In other implementations, the pulse response is measured from a test chip or other physical chip implementing the channel under consideration. It should be understood that the noninverted sampled pulse response can be used with any of the test sequence generation methods described herein. In such cases, the direction in which the test sequence is generated relative to pulse response will ordinarily be reversed.

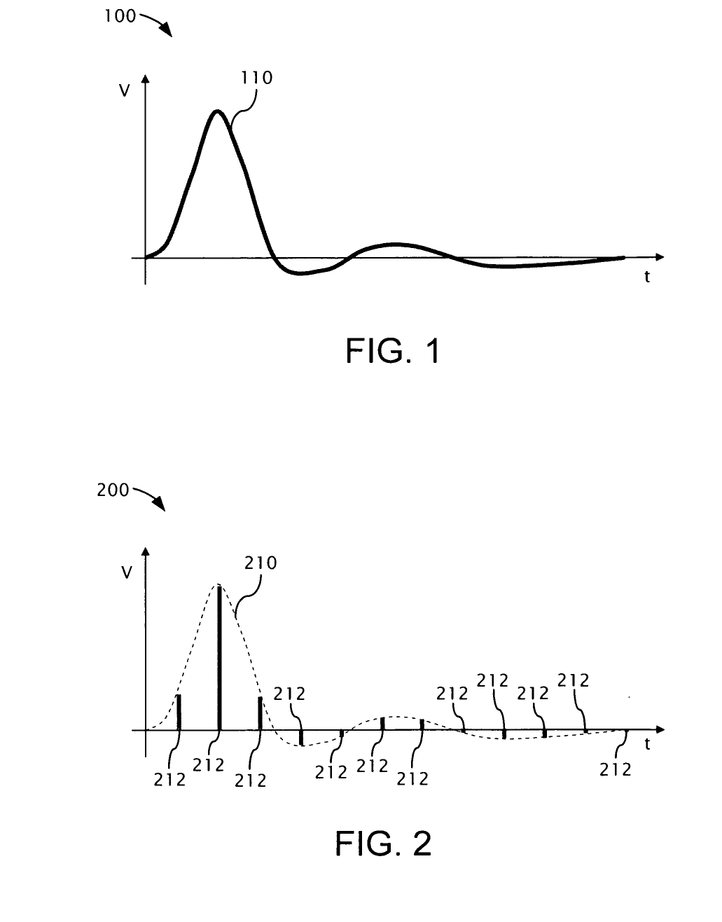

According to one exemplary implementation, the pulse response is assumed to be a factor 0.5 of the difference between the channel's response to a single bit pulse (e.g., representing the sequence “ . . . 010000000000000 . . . ”) and the constant level corresponding to the prolonged logical state “0”. In other implementations, the pulse response can be scaled using different factors or values. Because the start and end level of the pulse response is the same, the difference can be defined such that it starts and ends at a zero level, as illustrated by pulse response 110 shown in graph 100 of FIG. 1. In certain implementations, the samples of the pulse response are taken according to the bit rate, one sample per bit. FIG. 2 shows a graph 200 wherein samples 212 within a pulse response 210 are illustrated at intervals along the time axis corresponding to the bit rate of the channel under consideration.

In certain implementations, the input to the channel under consideration is assumed to be a two-level (binary) signal, also sampled with the bit rate. In the illustrated implementation, for example, the channel's input is assumed to have the following possible values: x(i)=+1 (corresponding to logical “1”) or −1 (corresponding to logical “0”). In this implementation, vertical scaling does not affect the solution.

The sampled output of the channel y(k) can be computed as a convolution between the channel's input x(k) and the response P(k), both sampled accordingly. For example, in certain desirable implementations, the following expression is used to determine the sampled output of the channel:

$$y ( k ) = {\sum }_{i = 1}^{k} P ( k - i ) x ( i ) \qquad ( 1 )$$

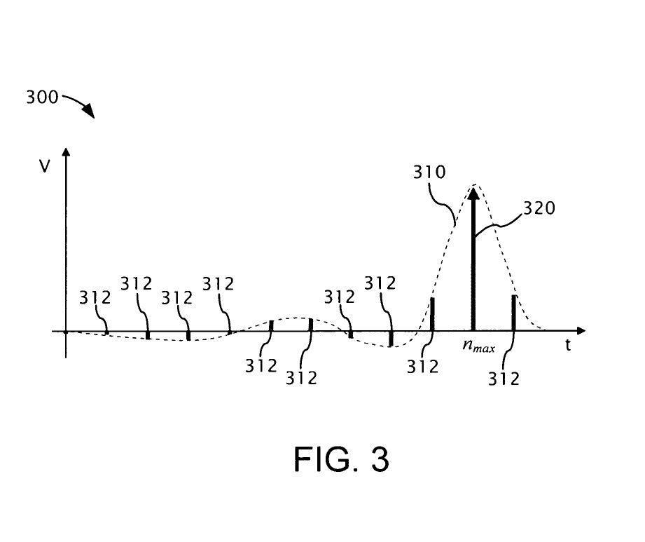

To simplify considerations, the sampled response P(k) can be inverted in time, thus producing an inverted sampled pulse response (Q(k)), such as inverted sampled pulse response 310 with samples 312 shown in graph 300 of FIG. 3. According to one exemplary implementation, the position of the largest positive peak in the response is denoted as nₘₐₓ: Q(nₘₐₓ)>|Q(n)|, n # nₘₐₓ In FIG. 3, the corresponding maximum sample value is shown with arrow 320.

1. Determining Unconstrained Test Sequences Representing the “Worst Case”

The system output can now be represented as:

$$y ( k ) = {\sum }_{i = 1}^{k} Q ( i ) x ( i ) . \qquad ( 2 )$$

From Expression (2), an unconstrained combination of input pulses x(k) that reduces the output at its last sample value y(N) can be found. For example, Expression (2) can be used to determine a test sequence that represents the “worst case” sequence. According to one exemplary implementation, one can assume that a logical “1” (the value intended to be output from the channel) corresponds to the level “high.” The value at the pulse maximum (arrow 320) can then be assigned to the value “+1”. That is, the input value x(nₘₐₓ) can be assigned to “+1” to represent the logical “1”. In one implementation, to find the unconstrained worst case sequence, the values of the rest of the input bits (x(n)) can be chosen arbitrarily so as to minimize (or otherwise reduce to a desirable level) the total output. For example, the following expression can be used:

$$min ( y ( N ) ) = min {\sum }_{n = 1}^{N} Q ( n ) x ( n ) . \qquad ( 3 )$$

Because x(n) is either +1 or −1, the minimum can be reached if, whenever possible, Q(n) and x(n) have opposite signs. Hence, in one exemplary implementation:

$$x ( n \neq {n}_{max} ) = \{ \begin{matrix}- 1 , & Q ( n ) \geq 0 \\ + 1 , & Q ( n ) < 0\end{matrix} . \qquad ( 4 )$$

### From Expression (4):

$${y}_{min} ( N ) = Q ( {n}_{max} ) - {\sum }_{n \neq {n}_{max}} \vert Q ( n ) \vert . \qquad ( 5 )$$

The above procedure can be applied to the samples of Q(n) directly. An example is shown in Table 1 below. In Table 1, the first column indicates the sample index (n), the second column indicates the value of Q(n) at the corresponding sample number, and the third column represents the value of the input bit in the corresponding position of the input sequence that would produce the unconstrained worst case sequence according to Expression (3). The leading bit (corresponding to the bit at nₘₐₓ) is shown in bold in the double-lined cell.

TABLE 1
Inverse Sampled Response and the Worst Case Sequence

| N | Q(n) | x(n), unconstrained | x(n), 8b10b | group desig. |
|---|---|---|---|---|
| | | | + | 4 |
| | | | + | |
| | | | + | |
| 1 | 0.001 | − | − | |
| 2 | 0.002 | − | + | 3 |
| 3 | 0.003 | − | − | |
| 4 | 0.005 | − | − | |
| 5 | 0.004 | − | − | |
| 6 | 0.003 | − | − | |
| 7 | 0.001 | − | + | |
| 8 | −0.001 | + | − | 2 |
| 9 | −0.003 | + | + | |
| 10 | −0.008 | + | + | |
| 11 | −0.010 | + | + | |
| 12 | −0.007 | + | + | 1 |
| 13 | 0.011 | − | − | |
| 14 | 0.023 | − | − | |
| 15 | −0.032 | + | + | |
| 16 | −0.081 | + | + | |
| 17 | 0.151 | − | − | |
| 18 | 0.768 | + | + | 5 |
| 19 | 0.072 | − | − | |
| 20 | 0.010 | − | − | |
| | | | − | |

2. 8b10b Sequence Constraints

As noted above, in certain implementations, it is desirable to generate the worst case sequence that complies with a given transmission code (e.g., the 8b10b, 4B5B, 6B8B, 64B66B, or other suitable transmission code). For illustrative purposes only, the disclosed technology is described as being applied to the 8b10b transmission code. It should be understood that the disclosed technology is readily adaptable to a wide variety of other transmission codes.

For the 8b10b protocol, and according to one exemplary embodiment of the disclosed technology, the following constraints are applied: (1) a bit group's individual disparity can only be −2, 0, or +2; (2) for a sequence of bit groups, the running disparity must alternate; and (3) the running length of any series of bits cannot exceed 5. These constraints are discussed in greater detail in the following paragraphs. It should be understood that when the disclosed techniques are applied to other transmission codes, other criteria may be adapted for those codes. Furthermore, while the embodiment described herein applies all three of the constraints, other embodiments use only or one or two (in any combination) of the constraints.

According to the 8b10b transmission code, the bit stream is divided into alternating bit groups of 6 and 4 bits. For each group, a disparity can be defined. In one implementation, the disparity is a number showing the balance between logical “1s” and “0s” in a bit group. If the bit group has an equal number of “1” and “0”s, its disparity is zero. Since the number of bits in a bit group is even, the smallest nonzero disparity will be either “−2” or “+2.” For example, the bit group “0101” has “0” disparity, “1101” has “+2” disparity, and “0100” has “−2” disparity. Furthermore, in this exemplary embodiment, a bit group is not permitted to have a larger disparity than “+2” or “−2.”

A running disparity builds by accumulating the individual disparities (sometimes referred to as the “partial disparities”) of the bit groups considered so far. Furthermore, and according to a particular implementation, an initial running disparity can be set to either a “+1” or “−1.” According to the running disparity constraints introduced above, a bit group having a negative running disparity is to be followed by a bit group having a neutral (“0”) or positive (“+2”) disparity. Similarly, a bit group having a positive running disparity is to be followed by a group having a neutral (“0”) or negative (“−2”) disparity. The subsequent group's disparity can be added to the existing running disparity, resulting in an updated running disparity. The updated running disparity can then be associated with the subsequent group. Thus, if the initial running disparity is “−1” and the subsequent group is “+2,” the running disparity value changes from “−1” to “+1” and the subsequent group is said to have a running disparity of “+1.” In certain implementations, a group with a neutral disparity does not change the value of the running disparity.

Running length indicates the number of “+1” or “0”s standing in a row. Because of the disparity considerations mentioned above, no group may have five “1”s or five “0”s. However, when the groups are concatenated, there may occasionally be five or even six identical bits in a row. For the embodiment following the constraints introduced above, a running length of six is avoided because such a running length is not allowed.

In certain implementations, the disparity and running length rules are invariant to a time inversion. For example, for sequences complying with the 8b10b protocol, when the sequence is presented in an inverse order, the inverted sequence will also be 8b10b compliant. Based on this observation, it follows that one can generate the sequences by propagating the disparity and running length rules in either direction, into the “future” or into the “past” or even by starting the building of the sequence at some point “in the middle.”

3. Building Worst-Case 8b10b Sequences

In one exemplary implementation, it is desirable to make the smallest number of modifications to the unconstrained worst case sequence in order to create a 8b 10b compliant sequence. It will ordinarily be necessary, however, to make some adjustments to achieve the desired group disparity and running length.

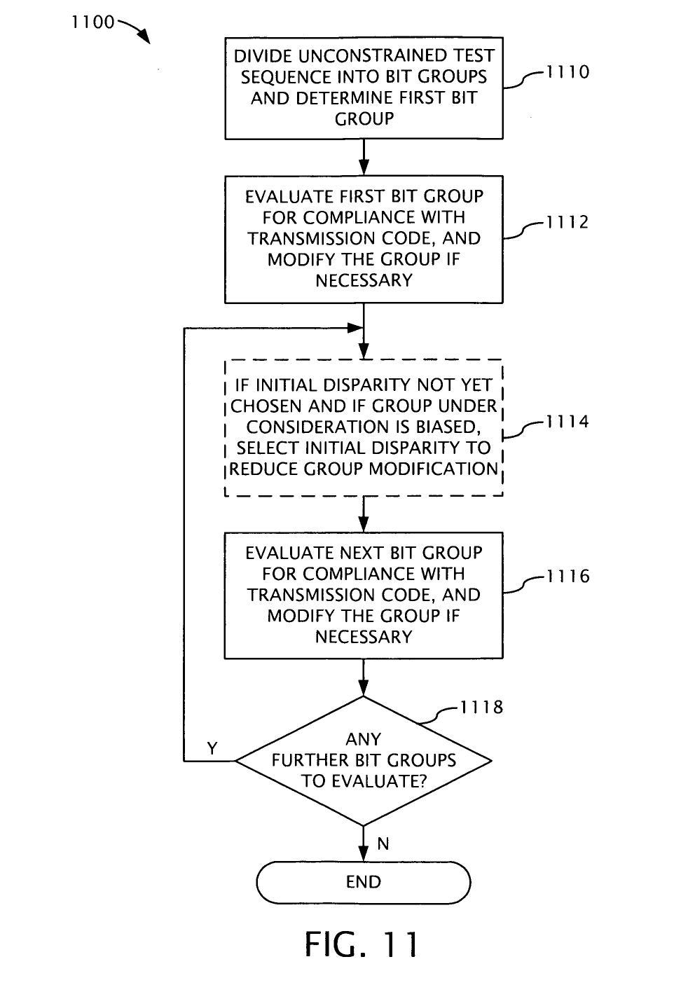

FIG. 11 is a flowchart 1100 showing a method of generating test sequences according to one exemplary embodiment. The method acts shown in FIG. 11 can, in certain circumstances, be performed in a different order, or performed alone or in various combinations and subcombinations with one another.

At 1110, the unconstrained test sequence (e.g., the unconstrained worst case sequence generated using Expression (3) above) is divided into bit groups and the location of the first group to generate in the test sequence is determined. Defining the first group (and, as discussed below, choosing the initial disparity) is a choice that can produce an overall reduction in the number of changes to the unconstrained group. For example, the initial running disparity of the first group is desirably selected so as to minimize (or otherwise reduce) the overall number of changes to the unconstrained test sequence. After the first group is chosen at 1110, the running disparity constraint will be considered, meaning that there is less choice in selecting the subsequent groups.

In one desirable embodiment, the group that corresponds to values having the greatest magnitude (by bit group) in the pulse response and excluding the leading bit is selected as the initial bit group. Typically, the group with values having the greatest magnitudes is the first post-leading-bit group (that is, the group of samples that directly follow the main (leading) bit). For the exemplary inverted response introduced above in FIG. 3, for instance, the group with values having the greatest magnitude is formed from the samples preceding the main bit. Specifically, the first group is selected to comprise the bits at positions n=17 . . . 12 and is designated as group I in the fourth column of Table 1. Note that in this example, a first group of 6 bits was selected, although a group of 4 bits would also have been a valid choice and could alternatively have been selected. In certain implementations, the sequence generating technique 1100 is performed multiple times (e.g., using all possible initial selections or any subset thereof), and the worst of the generated solutions selected.

At 1112, the first group is evaluated for compliance with the transmission code and modified if necessary. In one embodiment, the fewest changes possible are made to the group in order for it to comply with the transmission code. Techniques for modifying the group are discussed in more detail below with respect to method act 1114. In this example, the first group is already compliant with the 8b10b transmission code and no further modifications are necessary.

In this example, the first group (comprising “+−−++−” in the unconstrained solution) is initially considered neutral. In certain embodiments, its disparity can be left as neutral. Or, in some embodiments, when the first group is neutral, it is possible to designate the group as either having a positive or negative initial disparity. This selection can be made, for example, once the first biased group is encountered during application of the technique 1100 as shown by method act 1114 and can be selected so as to minimize or reduce the modifications made to the biased group or later-considered groups. In the illustrated embodiment, method act 1114 is typically only performed once (when the first biased group is encountered and as signified by the dashed lines in FIG. 11) and may be performed concurrently with method act 1116.

At 1116, the next bit group of the unconstrained test sequence is evaluated for compliance with the transmission code and modified if necessary. For example, the illustrated embodiment proceeds toward the front of the sequence, though other embodiments proceed in the opposite direction. In this example, the next group is group 2 shown in Table 1 having indexes 8-11. The 4 bits of the unconstrained group have the following polarities: “++++.” This is not a valid group in the protocol. Since the pre-existing disparity has not yet been defined, one can select the initial disparity at 1114 as being negative (e.g., in order to allow for more “1”s in group 2). This running disparity value (“−1”) is desirably stored, as it will be used when the top of the table is reached and the technique continues from the group beginning at n=18. In order to comply with the constraints introduced above, one of the “+” bits in the group with indexes 8-11 is desirably replaced by a “−.” In one exemplary implementation, the “+” bit to change is selected so as to further reduce (e.g., minimize) the impact to the resulting eye opening in an eye diagram. For example, Expression (3) can be used to determine which bit should have its polarity reversed. In certain embodiments, the smallest impact is produced if the sign corresponding to the smallest pulse response sample value in the group is selected. Here, for example, this value is 0.001 at n=8. Group 2 is now defined, and the running disparity is changed to positive (“+1”).

At 1118, a determination is made as to whether any further bit groups remain to be evaluated. If so, the technique 1100 returns to 1114, where the next bit group is evaluated. Otherwise, the technique 1100 terminates. In the illustrated embodiment, group 3 (indexes 2-7) is evaluated next. Group 3 is a group of 6 bits all being logical “0”s or “−”s. This is not a valid 8b10b group according to the constraints introduced above. Since the running disparity is positive, a group with negative disparity (“−2”) can be selected. In this example, two bits of group 3 are desirably converted into positive bits in order to comply with the disparity constraints. As before, the smallest samples within the group are selected. In the illustrated example, these are numbers n=2 and 7. Group 3 is now defined, and the running disparity is changed to negative (“−1”).

In the illustrated example, the technique 1100 has now reached the top of the unconstrained sequence in Table 1 and the top group is initially incomplete. In one desirable implementation, the samples are extended at the top (or bottom) of the table with zero values. Such extensions will not ordinarily affect the result estimated by Expression (3). The group with missing bits can therefore be built up as needed, by considering the existing and desired disparity. In the illustrated example, for instance, group 4 is filled with “+” bits in order to maintain the constraint that the groups have alternating disparity. Group 4 is now defined, and the running disparity is changed to positive (“+1”). Group 4 could alternatively have been filled with two positive bits and a negative bit, resulting in a neutral group.

In one implementation, the technique 1100 considers the bits at the end of the sequence (the bottom of the table) once the top is reached, though these bits could have been considered at any time after the initial group is determined. In the illustrated example, the bits having indexes 18-20 form an incomplete group. This group can be extended by adding one or more zero samples. In this example, the pre-existing disparity selected for group I was negative. Hence, group 5 can either be neutral or negative. Both are possible and no modification is required. In the illustrated example, a group with negative disparity is selected and the running disparity is modified accordingly. Now, with the running disparity updated, the technique could continue moving down the table if required.

The constraints applied in the exemplary technique 1100 described above can be summarized in a more formal fashion as shown in Table 2.

TABLE 2
Logical ‘ones’ to be replaced with ‘zeros’

| Pre-existing running | Group disparity | | | | | | |
|---|---|---|---|---|---|---|---|
| disparity | −6 | −4 | −2 | 0 | +2 | +4 | +6 |
| −1 | −3 | −2 | −1 | 0 | 0 | 1 | 2 |
| 0 (not yet initialized) | −2 | −1 | 0 | 0 | 0 | 1 | 2 |
| +1 | −2 | −1 | 0 | 0 | 1 | 2 | 3 |

For each possible value of the group disparity and pre-existing running disparity, Table 2 shows the number of bits in which “1”s should be changed into “0”s (or the reverse, if the number is negative). For example, let the running disparity be “−1” and the next (or subsequent) group be “001001”. This next group's self disparity is −2 (−4+2 =−2). From the first row and third column, a change of “−1” is desirable to comply with the 8b10b constraints. Thus, one O-to-I transformation can be used to make the bit group neutral. If the pre-existing running disparity for the same group is positive (“+1”), then Table 2 indicates that the group can remain unchanged, resulting in a running disparity equal to “−1” (+1−2=−1).

In the example described above, no modifications were required on account of an excessive running length. However, running “1”s violations can occur, for example when concatenating the following group pairs from the 8b10b protocol:

[001111][1100] → P6/Z4 (6-bit group with positive disparity, 4-bit with zero disparity)

### [000111][1110] → Z6/P4

### [0111][111000] → P4/Z6

### [0011][111100] → Z4/P6

Note that all of the above groups are either of the PZ or ZP type. Therefore, the pre-existing disparity could only be negative. With a negative pre-existing disparity, the subsequent groups could be one of the following: ZZ, PZ, ZP, PN (here N stands for negative group disparity). To reduce the impact from changing logical bit values, the number of group types changed can be minimized in certain desirable implementations of the disclosed technology. For example, if a running “1” violation is detected, the combinations PZ can be changed into ZZ or PN, depending on whichever group contains the smallest sample value that corresponds to the bit in the group of logical “1”s. Further, the combination ZP can be changed into ZZ.

Similar considerations can be made for running “0” violations. For example, in certain implementations, the solutions for running “0” violations are found by swapping “0”/“1” and “P”/“N” in the above discussion.

In general, the exemplary technique described above modifies the unconstrained worst case sequence to comply with the 8b10b protocol. For example, in the embodiment illustrated by Table 1, each 6- or 4-bit group was modified so as to minimize the difference between the constrained and the original unconstrained sequence. Minimization was made locally for each group without considering possible consequences for the groups to follow. Although the technique produces high quality worst-case sequences, the technique may not produce the worst case sequence. The second illustrative embodiment is an alternative method and does not modify the unconstrained worst case sequence. Implementations of the second illustrative embodiment produce even higher quality worst case sequences. For example, higher quality results can be obtained by considering the impact of a bit group globally in the sequence rather than locally. Certain implementations of the second illustrative embodiment are understood to produce the theoretical “worst case” sequence.

### B. SECOND ILLUSTRATIVE EMBODIMENT

Given a linear and time-invariant signal channel characterized by its pulse response, and the duration of the bit interval, another embodiment of the disclosed technology can be used to generate a binary pattern of a given length that complies with the 8b10b transmission protocol and creates the worst case sequence for testing signal integrity and bit error rates. For example, the sequences generated can produce the worst or near worst eye openings on an eye diagram (often used to provide a visual display of the signal quality on a channel being analyzed over many transitions).

In certain exemplary implementations, the test sequence generation technique uses the inverted sampled pulse response Q(k), k=1 . . . . N as input. The inverted sampled pulse response is discussed in more detail above. As with the implementations described above, it should be understood that the noninverted sampled pulse response can be used with any of the test sequence generation methods described herein. In such cases, the direction in which the test sequence is generated relative to pulse response will ordinarily be reversed.

Briefly, and according to one exemplary embodiment, the test sequence to be generated is first represented by a chart (or other appropriate data structure, model, table, or representation) indicating possible code word types (and accounting for possible word length and pre- and post-word disparity constraints) and the allowed transitions between them. Then, for one or more code word types, a candidate code word is selected (e.g., the “worst” candidate) from the code word table by estimating its individual “cost.” Individual costs can be estimated by element-by-element multiplication of the word bit values (e.g., “+1” or “−1”) with the corresponding portion of the sampled pulse response. If the current portion of the response contains the leading sample, the set of considered code words can be limited to those that contain “1” in the corresponding position.

A forward and backward sweep can be performed along the word sequence. In certain exemplary implementations, the forward sweep finds the “worst” choice (or other desirably bad choice) between the possible word types in each word position. In certain desirable implementations, this choice is based on estimating the cumulative cost (e.g., the sum of the individual cost and the cumulative cost from a respective word's “worst” predecessor). From the forward sweep, the final “worst” word in a sequence can be determined and its type defined.

The backward sweep is performed to identify the chain of predecessors that led to the final “worst” word. Among several cost values, for example, the “worst” choice can be determined by selecting the smallest value. As a result, the generated sequence produces a desirably small (and in some implementations, the smallest) product of the bit values and sampled pulse response, and thus produces a small (e.g., the minimum) eye-height measure. Additional details of these individual method acts are described in the sections below.

1. 8b10b Protocol Code Word Types and Tables

To represent the possible 8b10b coding words (also referred to as code words, bit groups, or groups) and their allowed transitions, each possible 8b10b coding word (or other desirable number of coding words) can be categorized into a fixed number of types. For example, in one exemplary implementation, a type is defined by a self disparity, and a resulting (post) disparity. For purposes of this discussion, a pre-existing disparity is denoted with a small prefix “n” (negative) or “p” (positive). The self-disparity, which may be P (positive), N (negative), or Z (zero) complemented by the group length, is set forth in the middle of the code word type. The postfix (“n” or “p”) shows the resulting running disparity. For example, the type “nP6p” is a 6-bit group with a negative pre-existing disparity, a positive self disparity, and a positive post-running disparity.

In general, for the 8b10b protocol, there are only eight group types available: nP6p, pN6n, nZ6n, pZ6p and nP4p, nZ4n, pN4n, pZ4p. Although the exemplary techniques described herein are not sensitive to the particular code words allowed for each group type, code words for each group type according to the 8b10b transmission code are shown in Table 3 for illustrative purposes.

TABLE 3
8b10b Code Words Used in Different Word Types

| NN | nP6p | pN6n | nZ6n | pZ6p | nP4p | pN4n | nZ4n | pZ4p |
|---|---|---|---|---|---|---|---|---|
| 1 | 011011 | 100100 | 110001 | 110001 | 1011 | 0100 | 1001 | 1001 |
| 2 | 111010 | 000101 | 101001 | 101001 | 1101 | 0010 | 0101 | 0101 |
| 3 | 110110 | 001001 | 011001 | 011001 | 1110 | 0001 | 1010 | 1010 |
| 4 | 001111 | 110000 | 100101 | 100101 | 0111 | 1000 | 0110 | 0110 |
| 5 | 101110 | 010001 | 010101 | 010101 | | | 1100 | 0011 |
| 6 | 011110 | 100001 | 110100 | 110100 | | | | |
| 7 | 101011 | 010100 | 001101 | 001101 | | | | |
| 8 | 100111 | 011000 | 101100 | 101100 | | | | |
| 9 | 011101 | 100010 | 011100 | 011100 | | | | |
| 10 | 101101 | 010010 | 100011 | 100011 | | | | |
| 11 | 110101 | 001010 | 010011 | 010011 | | | | |
| 12 | 111001 | 000110 | 110010 | 110010 | | | | |
| 13 | 010111 | 101000 | 001011 | 001011 | | | | |
| 14 | 110011 | 001100 | 101010 | 101010 | | | | |
| 15 | | | 011010 | 011010 | | | | |
| 16 | | | 100110 | 100110 | | | | |
| 17 | | | 010110 | 010110 | | | | |
| 18 | | | 001110 | 001110 | | | | |
| 19 | | | 111000 | 000111 | | | | |

Note that group types with neutral disparity and the same size may have common words. Most of the nZ6n and pZ6p words are similar, except for the last row. The same is true for nZ4n and pZ4p types. The reason the distinction was introduced between these neutral groups was to prevent running length violations. For example, after the “positive” word “001111,” the neutral word “0011” (type pZ4p) may follow, but not the neutral word “1100” (type nZ4n) which would create six “1”s in a row.

2. Code Word Type Transition Chart

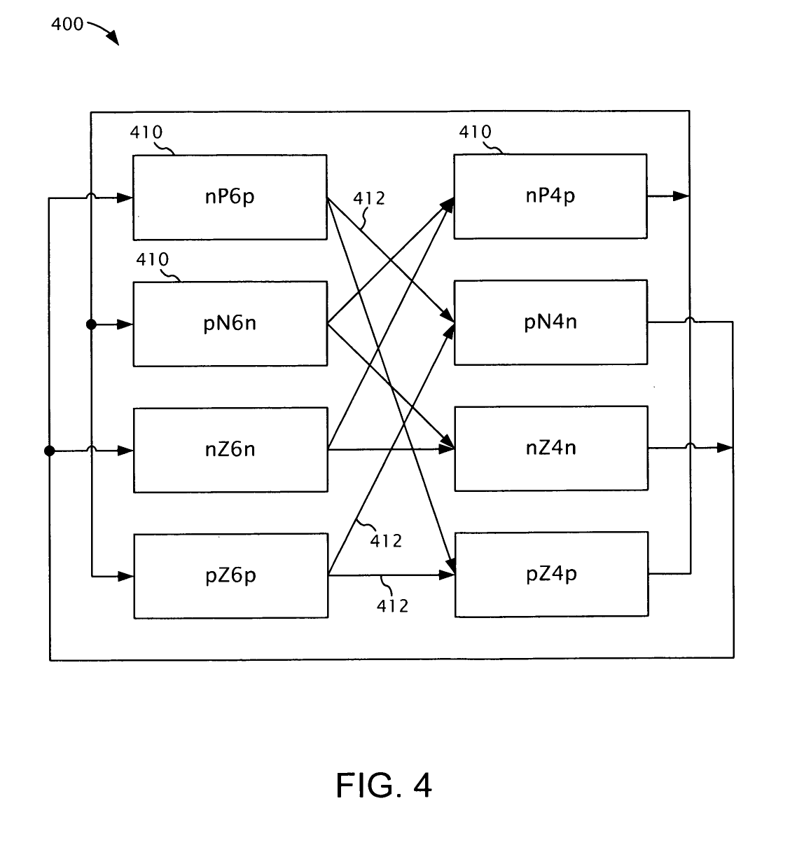

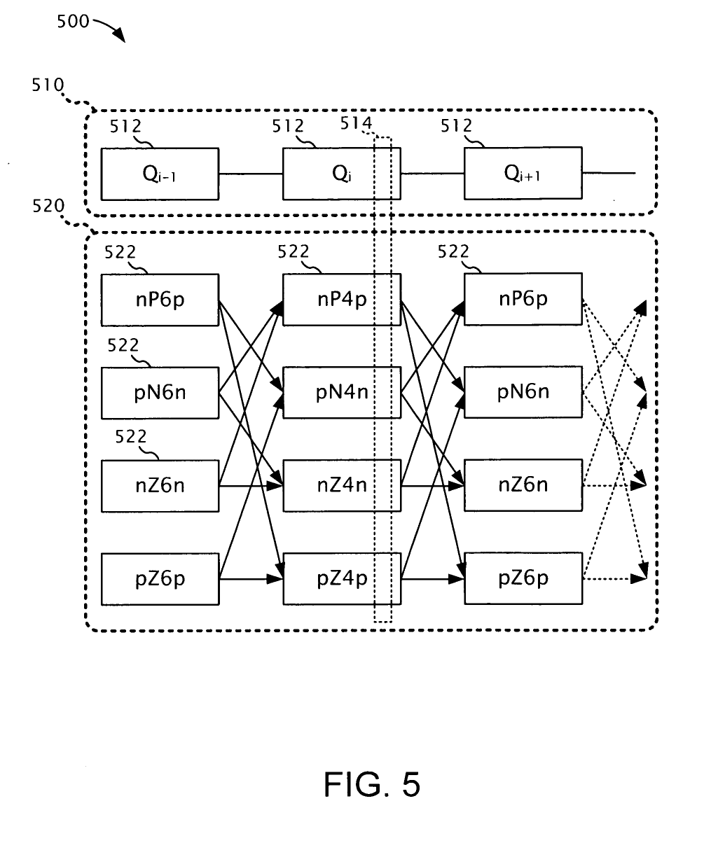

Using definitions such as those introduced above, rules can be formulated that indicate how the code word types may precede and follow each other according to any given transmission code (e.g., the 8b10b transmission code). For example, the available transitions between the code word types introduced above and for one exemplary implementation are shown in FIG. 4. In particular, FIG. 4 is a schematic block diagram 400 showing the various possible code word types 410 along with the possible transitions between the code word types (shown by arrows 412). For ease of illustration, only a few representative samples of the code word types 410 and arrows 412 are designated in FIG. 4. FIGS. 5, 6, and 7 similarly call out only a few representative code word type representations.

The rules followed by the exemplary implementation illustrated in FIG. 4 are derived from the constraints introduced above and comprise the following: (1) the resulting disparity of a word (indicated by its postfix according to the format introduced in the previous section) must be equal to the pre-existing disparity of the next code word type (indicated by the code word's prefix), and the code word lengths (6 or 4 bits) must alternate. Note that in this exemplary implementation, each code word type has two possible predecessors and two possible successor code word types.

As in the first representative embodiment, one goal to be achieved in exemplary implementations of the second representative embodiment is to reduce (or minimize) the relation:

$$min ( y ( N ) ) = min {\sum }_{n = 1}^{N} Q ( n ) x ( n ) \qquad ( 6 )$$

by appropriately choosing the code words constituting the binary sequence x(n). In Expression (6), Q(n) is the inverted sampled pulse response (as described above) for a channel under consideration. In general, the bit elements in x(n) can be chosen, but not in Q(n). In addition, a certain predefined bit of an index nₘₐₓ, can be assumed to be a logical “1”. Thus, x(nₘₐₓ) can be fixed to the logical “1”.

To illustrate the exemplary procedure, assume that a 6-bit group is chosen as the starting group for the sequence so that the sequence of groups constituting x(k) along with the response Q(k) can be arranged as in schematic block diagram 500 shown in FIG. 5. In particular, the diagram 500 of FIG. 5 includes a region 510 in which representations showing the values of the sampled pulse response in the corresponding group position Qᵢ are displayed. These representations are referred to herein as pulse response groups 512.

In FIG. 5, the group Qᵢ (a 4-bit group) is shown as having the leading bit position. In particular, frame 514 is a representation showing the location of the leading bit within the code word type representations 522 corresponding to group Qᵢ. The leading bit (e.g., the bit in the inverted sampled pulse response with the greatest value) can be oriented at other bit positions within the test sequence. For the 8b10b transmission code, for example, there are 10 different choices for how to orient the leading bit, as a pair of adjacent groups consists of 10 bits. In certain implementations, the procedure described below can be repeated for each such starting position (or for other numbers of the positions) in order to find the “worst” possible sequence. Furthermore, to make the terminal groups complete, and in certain exemplary implementations, a certain number of zero samples can be added at the beginning and/or at the end of a response Q(k).

At this point, the groups in Q(k) and x(k) can be assumed to be aligned and the position of the leading bit (and the group containing it) defined. From the resulting sequence of groups, a starting group (Q₁) can be identified (corresponding to the group Q₁ having the first values of the inverted sampled pulse response).

FIG. 5 also shows a code word region 520 that includes representations of the possible code word types that may be selected to create the worst-case sequence. A sample of these representations is shown as code word type representations 522. Conceptually, the representation 522 in FIG. 5 can be viewed as placeholders for four different types of codes words for each position i. In this example, each code word type representation 522 allows for storing its available predecessors, its optimal predecessor, its local cost value, a cumulative cost value, and its local (6- or 4-bit long) code word (or bit pattern).

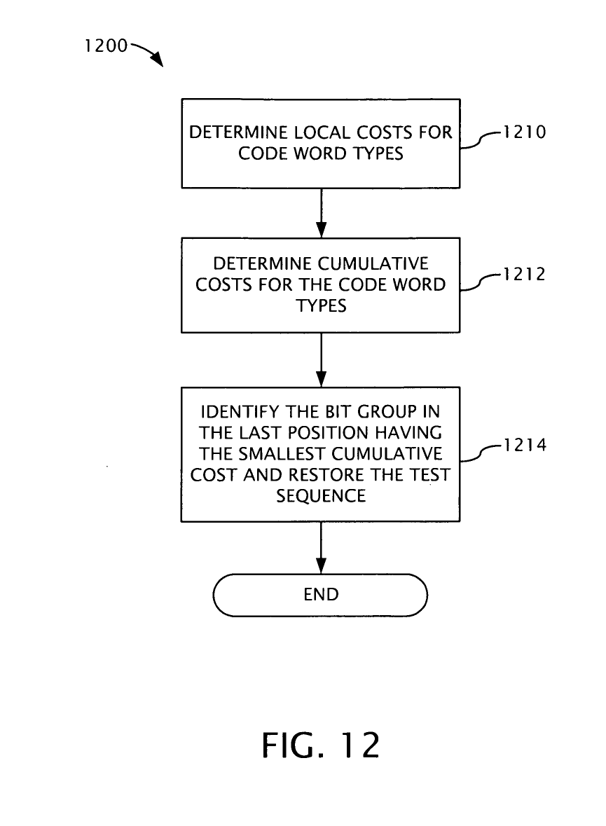

FIG. 12 is a flowchart 1200 showing one exemplary implementation for generating the worst-case sequence according to the disclosed technology. The method shown in FIG. 12 is performed using a chart, data structure, model, table, or representation arranged according to the format introduced above with respect to FIG. 5. Thus, the procedure 1200 assumes that a starting position has already been determined. As noted below, however, the procedure can be performed for each possible starting position, thereby creating different starting positions, and the overall worst sequence selected from the various results obtained. The method acts shown in FIG. 12 can, in certain circumstances, be performed in a different order, or performed alone or in various combinations and subcombinations with one another.

At 1210, local costs for each of the possible code word type representations can be determined. In particular, in one implementation, local optimums can be found for each index position i for each code word type at a respective index position (in alternative embodiments, only a subset of the index positions or code word types are considered). This act is performed because it is typically not yet known which code word type will be selected in every position. In one exemplary implementation, this method act can be performed by minimizing the relation

$$cos t ( j , type ) = {y}_{j , type} = {\sum }_{i = 1}^{4 or 6} {Q}_{j} ( i ) {x}_{j , type} ( i ) \qquad ( 7 )$$

by choosing from Table 3 the optimal code word for a certain type. The value determined can be obtained using the choice from Table 3 that minimizes (or otherwise reduces to a desirable level) Expression (7) and can be designated as a local cost for that code word type at its corresponding position. Conceptually, the local cost is a value indicative of how much a code word of a selected code word type impacts or alters the output of the channel when the code word is included in the test sequence.

At 1212, cumulative costs can be determined for the possible code word types. In one implementation, for every code word at every position, a cumulative cost and its optimal predecessor can be determined. For example, in one particular implementation, this method act comprises performing a sweep from left to right (or right to left). For the first code word position considered (e.g., the leftmost groups), the cumulative cost of each code word type is its own cost computed at 1210. For the next positions, i=2 . . . M, the cumulative cost of a code word type can be defined as a sum of its own local cost plus the smallest cumulative cost from its two available predecessors. At this point, the code word type representation stores an identity of its predecessor (or a pointer to it) having the smallest cumulative cost (e.g., by marking it as the “best” candidate predecessor). Conceptually, the cumulative cost for a code word type representation is a value indicative of how much a sequence of code words that includes the local bit group and one or more sequentially related bit groups (if any) impacts or alters the output of the channel when the sequence of code words is included in the test sequence.

At 1214, once the initial sweep is complete, the code word type representations 522 in the last position will contain cumulative costs that are “global” for the full test sequence being generated. From the four available alternatives, the code word type representation with the smallest cost can be identified. In this exemplary implementation, this element will belong to the chain of code word type representations constituting the worst sequence. Because predecessors were marked for each code word type representation during computation of the cumulative costs, the chain of code words that led to that result can be restored at 1214. In this embodiment, the restored chain defines the worst case sequence.

Method acts 1210, 1212, 1214, can be repeated for other possible leading bit orientations. For example, the acts can be repeated for all the possible leading bit positions (or a subset thereof) in order to find better solutions, such as the globally optimal solution.

In the method acts 1210 and 1212, the local costs of predecessors may occasionally become equal. In such situations, and in certain implementations of the disclosed technology, any of the predecessors can be selected. This selection typically does not affect the quality of the worst case sequence but only indicates that there are several sequences that produce equally closed eye diagrams. If desired, the technique can be modified so that all such possible sequences are generated and considered.

In the following paragraphs, an exemplary application of methods acts 1210, 1212, and 1214 is described. Assume for purposes of this example that the inversed pulse response contains 20 samples with sample values as shown in Table 4. In Table 4, the leading (sample) value is shown in bold.

TABLE 4
Example Inverted Pulse Response Q(n)

| | Sample |
|---|---|
| NN | value |
| 1 | −0.08 |
| 2 | 0.11 |
| 3 | 0.16 |
| 4 | 0.09 |
| 5 | 0.01 |
| 6 | −0.07 |
| 7 | −0.10 |
| 8 | −0.13 |
| 9 | −0.06 |
| 10 | 0.02 |
| 11 | 0.05 |
| 12 | 0.10 |
| 13 | 0.12 |
| 14 | 0.04 |
| 15 | 1.27 |
| 16 | 0.15 |
| 17 | 0.03 |
| 18 | −0.07 |
| 19 | −0.16 |
| 20 | −0.08 |

For method act 1212, it can be observed that any code group x_{i,type}, standing in a position i and having the type type={nP6p, pN6n, nZ6n, pZ6p and nP4p, nZ4n, pN4n, pZ4p} can be replaced with another group from Table 1 having the same type, without any consequence from the disparity and running length rules.

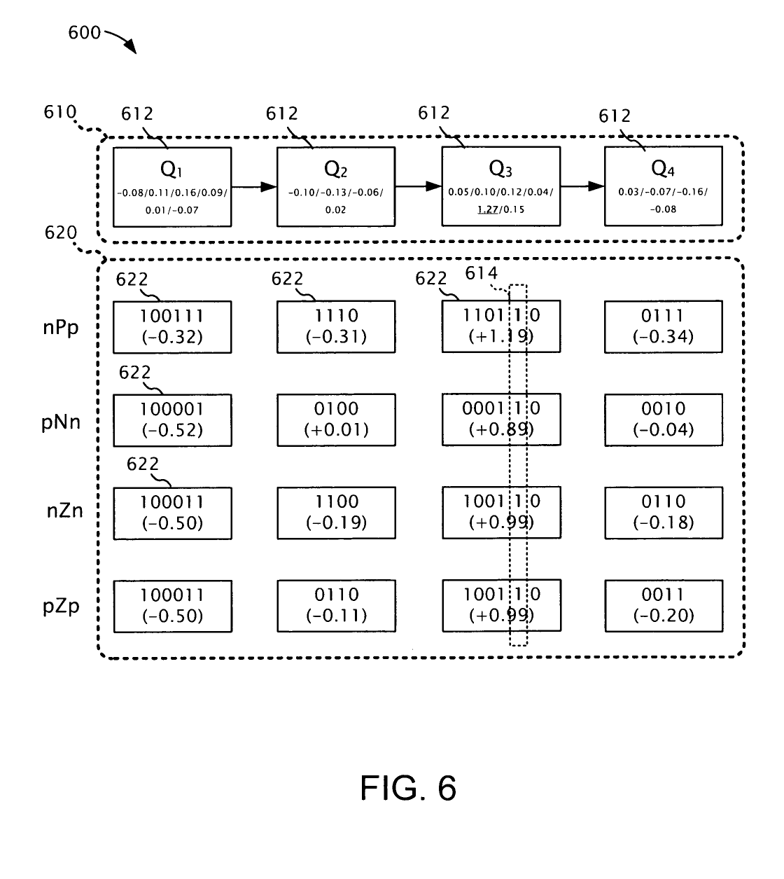

FIG. 6 is a schematic block diagram 600 in the form of the diagram 500 in FIG. 5 and shows the result of method act 1212 for this example. In particular, the code word type representations 622 in the code word region 620 show the selected code word (selected from Table 3) and the local cost of each selected code word. In this example, for each particular 6- or 4-bit portion of the response Q, (Qᵢ, i=1 . . . 4) and each possible code word type (nPp, pNn, nZn or pZp), the word that makes the smallest local cost as defined by Expression (7) can be found from Table 3. For example, of the code words corresponding to response group Q₁=[−0.08, 0.11, 0.16, 0.09, 0.01, −0.07], the code word “100111” creates the smallest cost among words of type nPp and size 6. Remember that in Expression (7), a logical “1” means taking the value with sign “+” and logical “0” means taking the value with sign “−”. Hence, the local cost for this word in this position is defined as:

Cost(1, nPn)=(−0.08)−(0.11)−(0.16)+(0.09)+(0.01)+(−0.07)=−0.32 (8)

It is easy to verify that no other code word of this type and in this position gives a smaller cost.

In certain implementations, the response group that contains the “leading bit” is treated differently. In this example, assume that the leading bit (shown by frame 614) is the 5-th bit in the third pulse response group (Q₃). For this position, when looking for a word with the smallest cost, those without a logical “1” in the leading bit position are ignored. Note, for instance, that all code words corresponding to pulse response group Q₃ of this example have a logical “1” at the fifth bit.

At this point, method act 1212 is considered complete. The fragments of the worst case sequence are already defined, although alternatives may exist concerning how to combine the fragments together.

For method act 1214, it is known that each code word may have two different predecessors as was illustrated by FIG. 4. One of the predecessors, however, may have a smaller cumulative cost, defined as the sum of its own cost and the cumulative cost of its best predecessor.

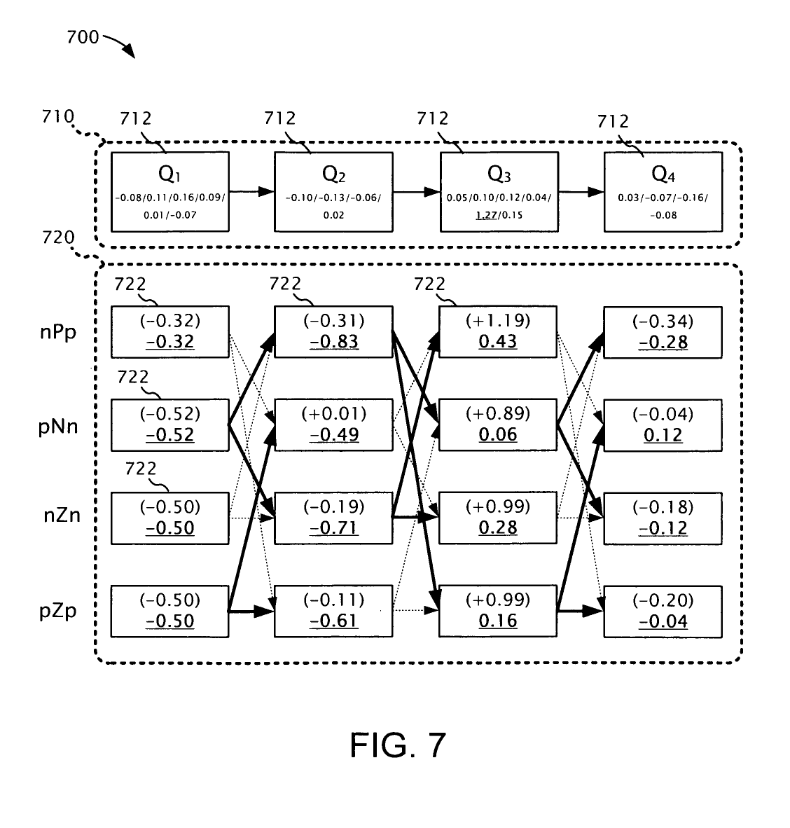

The procedure of establishing the cumulative cost and best predecessors according to one exemplary implementation is illustrated by schematic block diagram 700 shown in FIG. 7. Block diagram 700 also has the form of the diagram 500 in FIG. 5. Starting the process from left to right (though the procedure may similarly be performed from right to left or other sequences, with equally good results), for the leftmost code word type representations 722 in the code region 720 (corresponding to the pulse response group Q₁), the cumulative costs are defined (shown underlined and bolded) and are equal to their local costs (shown in parentheses). In the next column (second from the left and corresponding to the pulse response group Q₂), the local cost is already known but not the cumulative cost. Each code word type representation may have two predecessors, as indicated by the arrows. However, in this exemplary implementation, the predecessor having the smallest cumulative cost is selected. According to one exemplary embodiment, the cumulative cost can be defined as:

Cum. cost=local cost+cum. cost of the best predecessor. (9)

For example, the code word type representation nZn of size 4 in the second column (corresponding to response Q₂) has a local cost of −0.19. It also has two predecessors: pNn in the first column (corresponding to response group Q₁) with cumulative cost −0.52, and nZn in the first column with a cumulative cost −0.50. The first code word type representation (pNn) has the smallest cumulative cost. Therefore, it is marked as the best predecessor for the code word type representation nZn, and its cumulative cost is used to find the cumulative cost of the code word type representation nZn: cum. cost of (nZn, 2)=−0.19−0.52=−0.71. At the end of the sequence (here, at the fourth column corresponding to response group Q₄), the final cumulative costs are determined.

At method act 1214, the smallest cumulative cost (“−0.28”) is identified as belonging to the code word type representation nPp in the final column. The sequence order that led to this code word type representation can then be restored. The restoration process in the illustrated implementation is straightforward because the preferred predecessors have all been marked (e.g., using pointers). FIG. 7 illustrates the preferred predecessors through undashed arrows. The chain of code word type representations producing the worst case sequence can therefore be restored with a reverse sweep (from right to left), which produces the following sequence:

pN6n → nP4p → pN6n → nP4p

The bit content of the representations was already defined during method act 1212, as shown in FIG. 6. Combining the bits together, the following worst sequence is generated:

100001 1110 000110 0111

Note that this sequence represents the solution for a particular starting bit choice. The method acts 1212, 1214, 1216 can be repeated for multiple other starting positions in order to find a global solution. To do so, it may be necessary to add a few zero samples for alignment.
III. Generating Test Sequences in Cases of Bit Sequences with Duty-Cycle Distortion (“DCD”)

At least two different types of DCD have been identified: DCD as a periodical clock-related issue and DCD as a data-dependent phenomenon.

The first type of DCD (“periodical clock-related DCD” or “clock-related DCD”) can result in odd and even bits having slightly different durations, regardless of the signal level of those bits. The source of this type of DCD is typically a non-90-degree phase shift between lower frequency clock signals in the transmitter multiplexer. With this type of DCD, a DC level changes when there is a change in the polarity of the alternating input data sequence “01010101 . . . ” (when even bits become “0”, not “1”).

The second type of DCD (“data-dependent DCD”) results in a data-dependent pulse width variation (because of the threshold shift or unequal pull-up/pull-down strength). Here, the duration of pulses of level “1” is different from those of level “0”. With this type of DCD, a DC level does not typically change when the polarity is flipped in an alternating sequence “01010101 . . . ”

A. Generating Test Sequences for Periodical Clock-Related DCD

1. Building the Synthetic Sampled Pulse Responses for Even and Odd Bit Samples

In this section, embodiments for generating test sequences for clock-related DCD when the period of the input signal is equal to twice the bit interval and contains two unequal periodically repeating subintervals are described. Embodiments for more general cases where the period may contain more than two unequal subintervals will also be discussed.

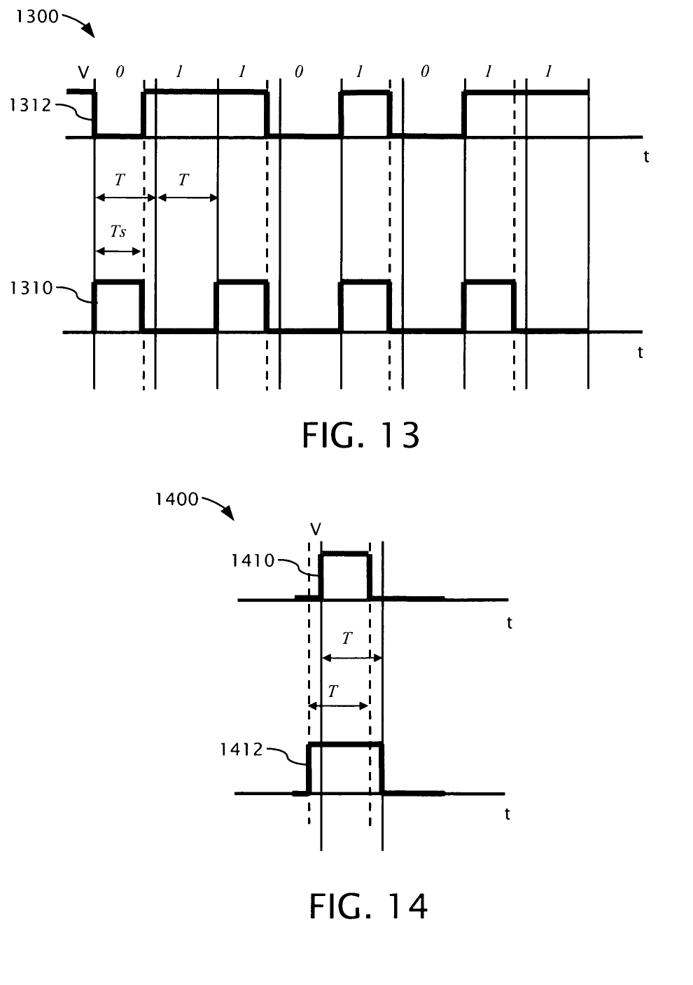

FIG. 13 is a graph 1300 of two exemplary waveforms illustrating clock-related DCD. The periodical clock-related DCD is produced by the non-ideal—though 2T periodic—clock signal 1310. The desired positions of switching times (if there were no DCD) are shown as solid vertical lines in FIG. 13 and are equally spaced with a period T. However, since the odd bits in this example are shorter than the even bits (or similarly, even bits could be shorter than odd bits), each odd and following even bit (or reverse) are separated by the dashed vertical line that is shifted from its “proper” or ideal position. As can be seen, the duration of a pulse in bit sequence 1312 does not depend on whether it is logical “1” or “0”, but only on its position relative to the clock signal. Generally, DCD can be measured as 50% (Tₛ/T).

In certain embodiments of the disclosed technology, the desired result of the worst case sequence generating process is to build an input bit pattern that for a given linear channel, bit period, and DCD produces the worst case eye opening. Similar to the case of ideal clocking (examples of which are discussed in the previous sections), the input signal (e.g., the bit sequence 1312 in FIG. 13) can be described as:

$$x ( t ) = {\sum }_{n = 0}^{N} {α}_{n} {\prod }_{n} ( t - nT ) \qquad ( 10 )$$

In Expression (10), the coefficients an correspond to logical “high” and “low” and could be taken, for example, as “+1”/“−1”. The function Πₙ(t) describes a rectangular pulse that depending on the subscript n could either be “even” or “odd”:

Πₙ(t)=Πₑᵥₑₙ(t) if n=2×k, k=0 . . . K, or

Π_{odd}(t), if n=2×k+1, k=0 . . . K. (11)

FIG. 14 is a graph 1400 showing elementary functions Πₑᵥₑₙ(t) (waveform 1410) and Π_{odd}(t) (waveform 1412).

As follows from Expression (10), the input signal x(t) can be composed from these functions by scaling and shifting them by nT, with n even for Πₑᵥₑₙ(t) and n odd for Π_{odd}(t). The output y(t) then can be found through the convolution integral:

$$\begin{matrix}\begin{matrix}y ( t ) = {\int }_{0}^{t} h ( t - τ ) x ( τ ) d τ \\ = {\int }_{0}^{t} h ( t - τ ) {\sum }_{n = 0}^{N} {α}_{n} {\prod }_{n} ( τ - nT ) d τ \\ = {\sum }_{n = 0}^{N} {α}_{n} {\int }_{0}^{t} h ( t - τ ) {\prod }_{n} ( τ - nT ) d τ \\ = {\sum }_{n = 0}^{N} {α}_{n} {P}_{n} ( t - nT ) .\end{matrix} & ( 12 )\end{matrix}$$

In Expression (12), h(t) is a channel's Dirac impulse response, and Pₙ(t) is a response to either the “even” or “odd” rectangular pulse as shown in FIG. 14. (Note that when applying the input rectangular pulses to the linear system, it is desirable to keep the relative delays as shown in FIG. 14.)

The output for the fixed moment of observation (t=tₛₐₘₚₗₑ) can be defined:

$$y ( {t}_{sample} ) = {\sum }_{n = 0}^{N} {α}_{n} {P}_{n} ( {t}_{sample} - nT ) \qquad ( 13 )$$

Here, the output value is just a weighted sum of samples of responses to rectangular pulses, Πₑᵥₑₙ(t) and Π_{odd}(t), taken at bit intervals.

In previous embodiments described in this application, the test sequence generation process used the inverted sampled pulse response of the linear channel as input. Here, as there exist two different input building block functions, two separate pulse responses Pₑᵥₑₙ (t) and P_{odd}(t) are generated that produce two inverted sampled pulse responses participating in Expression (12). With index n increasing, the even and odd responses Pₙ in Expression (12) desirably alternate.

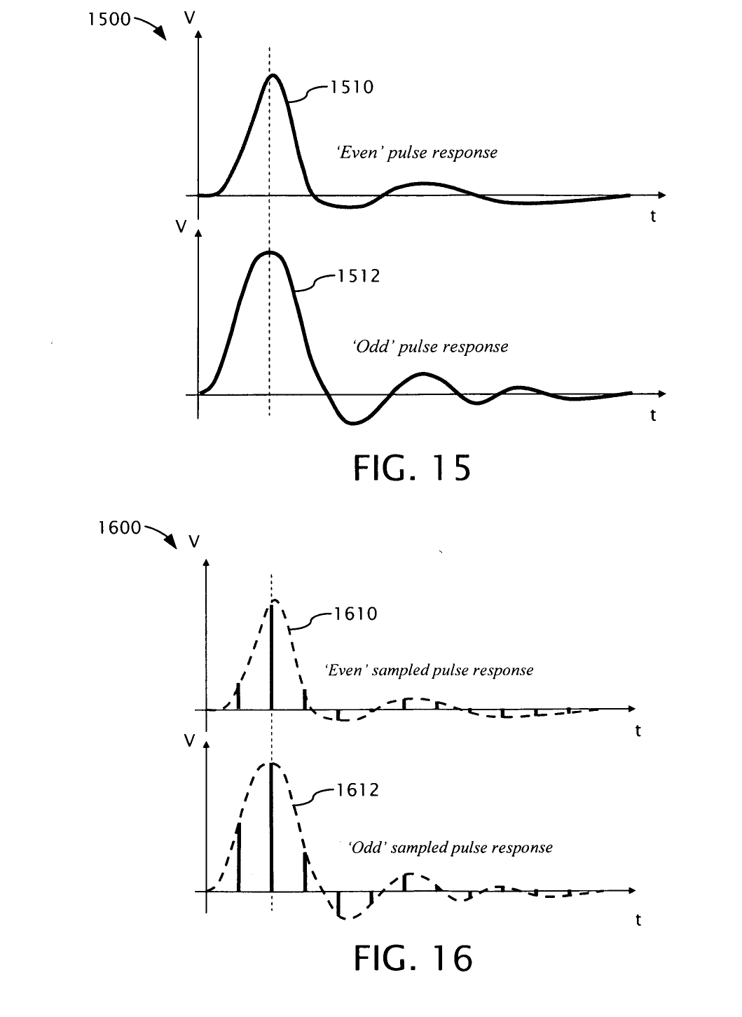

For example, let the responses Pₑᵥₑₙ(t) and P_{odd}(t) be the exemplary responses 1510, 1512 shown in graphs 1500 of FIG. 15. In particular, assume response Pₑᵥₑₙ(t) is waveform 1510 and response P_{odd}(I) is waveform 1512 in FIG. 15. Dashed vertical line 1502 in FIG. 15 corresponds to the position of a reference sample point tₛₐₘₚₗₑ chosen at the channel's output. The sample position is desirably selected so as to target a particular bit value, somewhere around the response's maximum. Now, as there exist two different responses, their maximums may be reached at different times. In certain exemplary embodiments of the disclosed technology, however, the particular choice is not important to generating the worst case sequence. Instead, one can just assume that some sample point position has been selected and the worst case sequence can be built for that particular selection. Additional details about determining the pulse response are described above with respect to the first illustrative embodiment for generating test sequences for channels with no duty-cycle distortion.

Now, as pulse responses exist and a sample point position has been selected, pre- and post-sample positions (also referred to as “cursors”) in bit intervals along the pulse responses can be determined. The resulting sample values at each of the sample positions can then be determined. As can be seen from FIG. 16, for example, only the discrete sample values can be considered as producing an effect on the output. In particular FIG. 16 includes graphs 1600 showing sampled pulse response waveform 1610 corresponding to response Pₑᵥₑₙ(t) and sampled pulse response waveform 1612 corresponding to response P_{odd}(t).

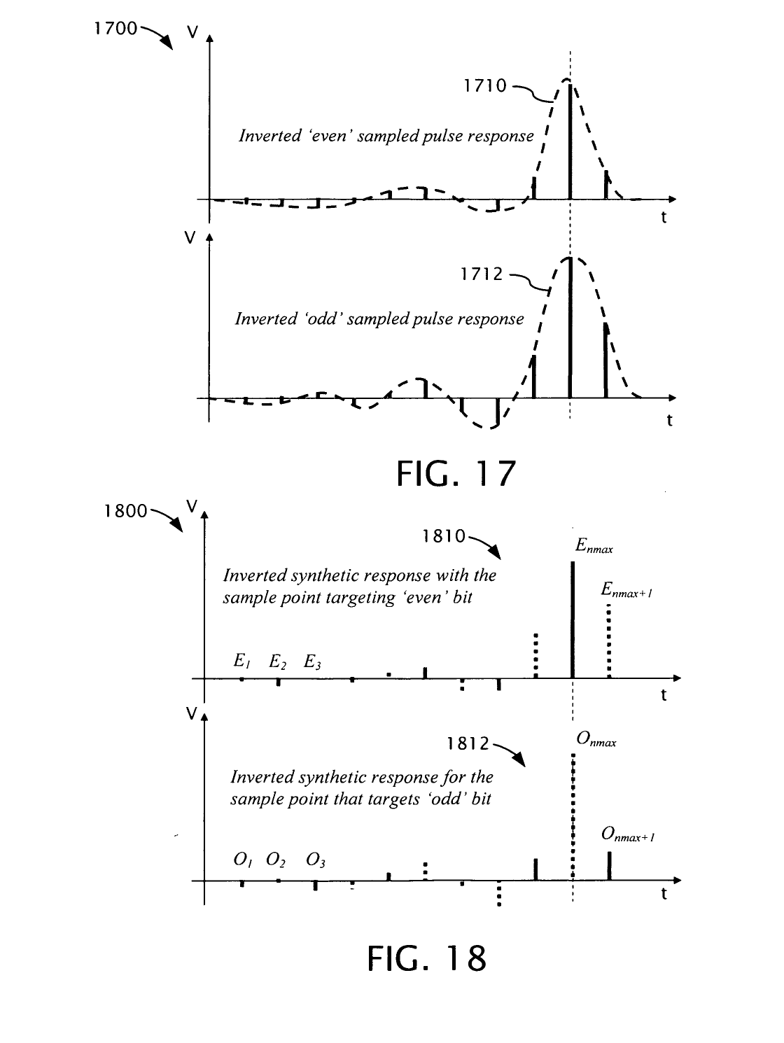

For convenience, one can “invert” the above sampled responses in time to address the negative sign at index n in the timing argument in Expression (12). The result of this inversion is shown in graph 1700 shown in FIG. 17. In particular FIG. 17 is a graph 1700 showing inverted sampled pulse response waveform 1710 corresponding to response Pₑᵥₑₙ(t) and inverted sampled pulse response waveform 1712 corresponding to response P_{odd}(t). Now, for a given input bit pattern, defined by its coefficients αₙ ε{−1; 1}, one can directly find the contribution each bit may bring to the sampled values in the inverted sampled pulse response, be it either “even” or “odd”.

From analyzing Expression (12), it can be seen that the contributions from “even” and “odd” bits alternate. Therefore, the weighting coefficients at αₙ apply alternatively to the sampled values from the first waveform 1710 (even) and the second waveform 1712 (odd). This is equivalent to defining a “combined” or “synthetic” sampled pulse response by alternating the sampled values from the first waveform 1710 with the sampled values of the second waveform 1712, as shown in graphs 1800 of FIG. 18. In particular, FIG. 18 shows an exemplary inverted synthetic response 1810 with the sample point targeting an “even” bit and an exemplary inverted synthetic response 1812 with the sample point targeting an “odd” bit. For purposes of illustration, sampled values taken from the second inverted sampled pulse response waveform 1712 corresponding to response P_{odd}(t) are shown dashed. In this manner, and in particular embodiments of the disclosed technology, two different synthetic responses can be produced, where the first one is used to target the input bit corresponding to the “even” position, and where the second one does the same for the “odd” bit position.

2. Building Unconstrained Worst Case Sequences

With the synthetic responses produced, and in one exemplary embodiment of the disclosed technology, Expression (12) can now be re-written as:

$$\begin{matrix}y ( {t}_{sample\_even} ) = {\sum }_{n = 0}^{N} {α}_{n} {E}_{n} & ( 13 ) \\ y ( {t}_{sample\_odd} ) = {\sum }_{n = 0}^{N} {α}_{n} {O}_{n} . & ( 14 )\end{matrix}$$

Two relations are used because the sampled bit can be either “even” or “odd”. The coefficients Eₙ and Oₙ correspond to the sampled values at the cursor positions used to create the synthetic response (e.g., as shown in FIG. 18). According to one exemplary embodiment, to build the unconstrained worst case pattern, one desirably selects the coefficients αₙ in Expressions (13) or (14) so as to minimize the sum while keeping the target bit coefficient α_{n max}=+1. In certain implementations, this can be accomplished as follows:

If the target bit is “even,” one can

$${α}_{n} ( n \neq {n}_{max} ) = \{ \begin{matrix}- 1 , & {E}_{n} \geq 0 \\ + 1 , & {E}_{n} < 0\end{matrix} ,$$

select that makes

$${y}_{min\_even} = {E}_{n max} - {\sum }_{n \neq {n}_{max}} \vert {E}_{n} \vert . \qquad ( 15 )$$

Targeting the “odd” bit, one can select

$${α}_{n} ( n \neq {n}_{max} ) = \{ \begin{matrix}- 1 , & {O}_{n} \geq 0 \\ + 1 , & {O}_{n} < 0\end{matrix}$$

and get

$${y}_{min\_odd} = {O}_{n max} - {\sum }_{n \neq {n}_{max}} \vert {O}_{n} \vert . \qquad ( 16 )$$

One can now find the smallest value between Expression (15) and (16) for each bit position in the sequence and thereby determine a full test sequence. This sequence represents the unconstrained worst case sequence of a given length that makes the sample reading smallest and maximizes reading error. It should be noted that the set of coefficients used desirably starts with the appropriate (even or odd) bit, so as to associate the leading cursor (nₘₐₓ) with the bit of a proper oddity.

3. Building Worst Case Sequences Obeying the 8b10b Protocol

Certain details of the embodiments described below are the same as introduced above for the embodiments for building the worst case sequence obeying the 8b10b (or other desirable protocol) for a single inverted sampled pulse response of a system with ideal clocking. For ease of presentation, some of these details are not repeated in the discussion below but are understood to apply.

To address DCD issues, the exemplary procedures introduced above can be applied twice for the responses Eₙ and Oₙ (e.g., once for the combined inverted response 1810 and once for the combined inverted response 1812 shown in FIG. 18). For example, in one particular implementation, the procedure of FIG. 12 and its accompanying discussion is applied twice. Then, according to one exemplary embodiment, the solution that produces the smallest reading value is selected. Further, it is desirable that the resulting coefficients are properly associated with even/odd bits, as in the case of the unconstrained sequence.

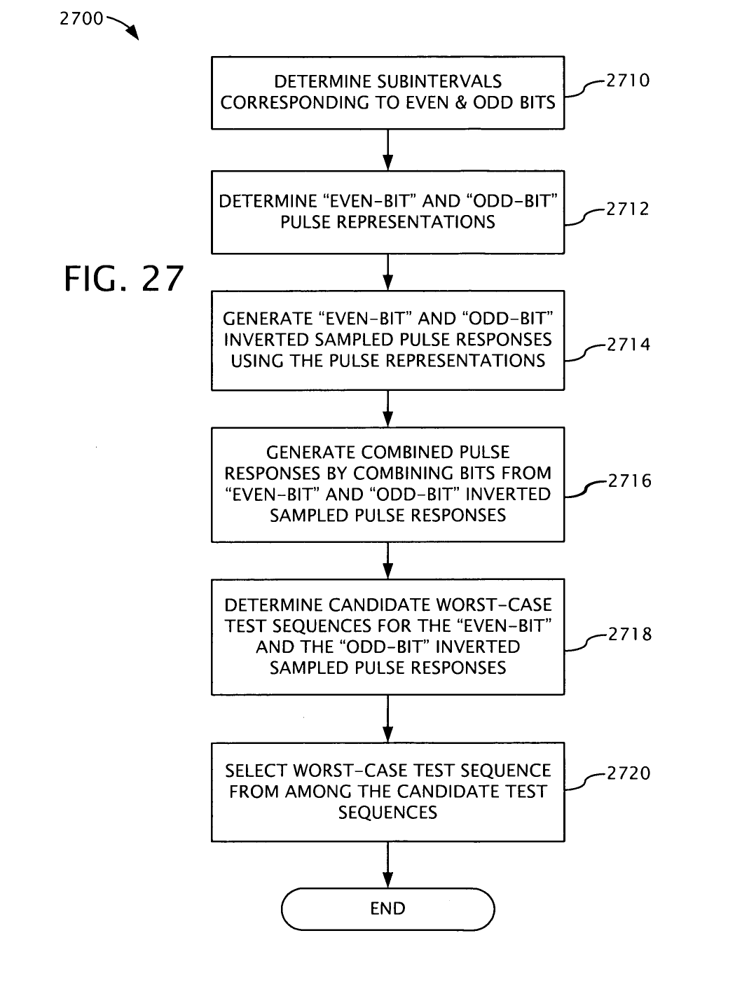

FIG. 27 is a flowchart 2700 illustrating an implementation of the exemplary embodiment introduced above. The method shown in FIG. 27 can be performed using a chart, data structure, model, table, or representation arranged according to the format introduced above with respect to FIG. 5. The method acts shown in FIG. 27 can, in certain circumstances, be performed in a different order, or performed alone or in various combinations and subcombinations with one another.

At 2710, the even and odd subintervals within the period of the input signal are determined. For example, a clock chart (or other appropriate data structure, model, table, or representation) is generated that defines the even and odd subintervals within a period relative to the ideally clocked subintervals. The clock chart (or other appropriate data structure, model, table, or representation) can describe, for instance, the various delays that may be present and can comprise information similar to that shown in FIG. 13.

At 2712, R rectangular pulse representations can be determined for each of the subintervals, keeping their delays relative to the ideal clock. For instance, rectangular pulse representations for rectangular pulses such as those shown in FIG. 14 can be determined.

At 2714, for each of the pulse representations, the corresponding pulse response (e.g., as shown in FIG. 15) and the corresponding inverted sampled pulse response (e.g., as shown in FIG. 17) are determined. In some embodiments, the noninverted sampled pulse response (e.g., as shown in FIG. 16) is also determined or determined instead of the inverted sampled pulse response. The pulse responses can be determined through simulation, a test chip, or other physical chip implementing the channel under consideration. The sampled pulse responses can be determined, for example, from the simulation or test results.

At 2716, synthetic (combined) pulse responses are generated by combining in an alternating fashion sampled values from the even-bit and odd-bit pulse responses. In one exemplary implementation, two different synthetic pulse responses are generated: one targeting the even bit (shown, for example, as inverted synthetic response 1810) and one targeting the odd bit (shown, for example, as inverted synthetic response 1812).

At 2718, a candidate worst-case sequence is generated for each of the pulse responses generated. Any of the embodiments discussed above for generating worst-case sequences can be used. In one particular embodiment, the method of FIG. 12 is applied to each of the generated pulse responses. Furthermore, the worst-case test sequence generation procedure can be repeated for each of the possible leading bit orientations. For example, the acts of method 1200 can be repeated for all the possible leading bit positions (or a subset thereof) in order to find better solutions, such as the globally optimal solution.

At 2720, the worst-case sequence that creates the riskiest reading value is selected (e.g., the smallest value for the level “1”) from among the candidate worst-case sequences. The sequence selected can be stored on one or more computer-readable media. The sequence selected can then be used as part of a signal integrity test. When so used, it is desirable to properly position the sequence in the input stream so as to synchronize its designated sample bit (of an index nₘₐₓ) with the appropriate subinterval of the clock signal.

4. Cases where there Exist Many Unequal Sub-Intervals in the Period

The exemplary solution discussed above is applicable to clock-related DCD with two unequal subintervals in a period. A more general case, however, is when a multiplexer contains several stages that due to non-ideal phasing produces DCD that may be described by R>2 unequal bit subintervals (say, τᵣ, r=1 . . . R) making the total period equal R*T (where T as before is a bit interval).

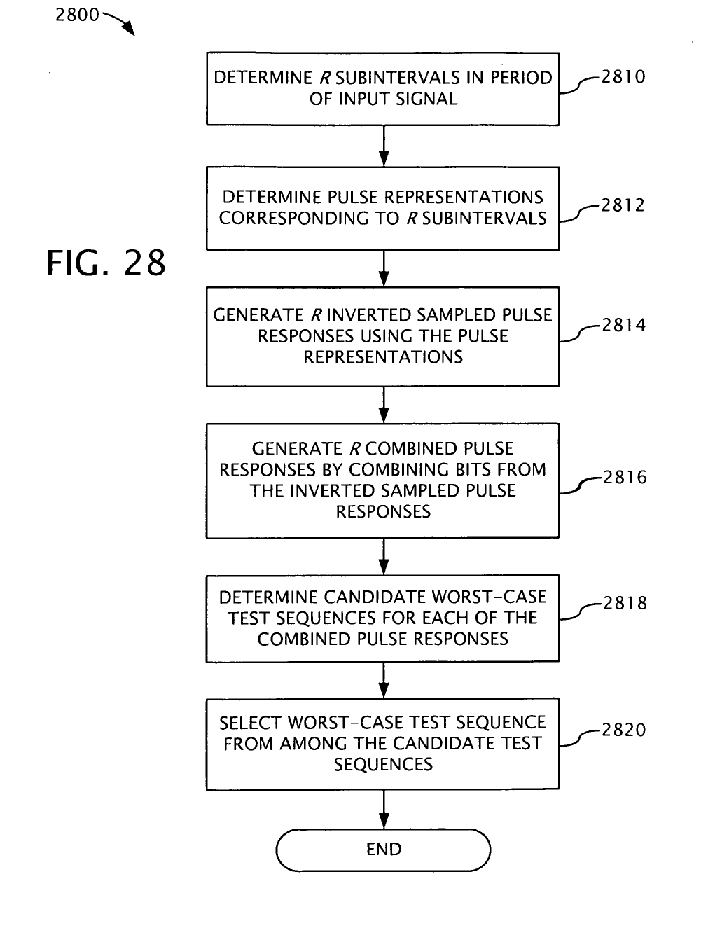

An exemplary approach for this general case comprises stages similar to those used in the case where R=2 and is illustrated in FIG. 28. In particular, FIG. 28 is a flowchart 2800 illustrating one exemplary embodiment for generating a worst-case sequence for clock-related DCD where the period comprises more than two sub-intervals.

At 2810, R subintervals within a period of the input signal are determined. For example, a clock chart (or other appropriate data structure, model, table, or representation) is generated that defines R subintervals within a period relative to the ideally clocked subintervals. The clock chart (or other appropriate data structure, model, table, or representation) can describe, for instance, the various delays that may be present and can comprise information similar to that shown in FIG. 13.

At 2812, R rectangular pulse representations can be determined for each of the subintervals, keeping their delays relative to the ideal clock. For instance, rectangular pulse representations for rectangular pulses such as those shown in FIG. 14 can be determined.

At 2814, for one or more of the pulse representations (e.g., for each of the R pulse representations), the corresponding pulse response (e.g., as shown in FIG. 15) and the corresponding inverted sampled pulse response (e.g., as shown in FIG. 17) are determined. In some embodiments, the noninverted sampled pulse response (e.g., as shown in FIG. 16) is also determined or determined instead of the inverted sampled pulse response. The pulse responses can be determined through simulation, a test chip, or other physical chip implementing the channel under consideration. The sampled pulse responses can be determined, for example, from the simulation or test results.

At 2816, synthetic (combined) pulse responses are generated by combining sampled values from the pulse responses determined. In one exemplary implementation, R different synthetic pulse responses are generated. In this implementation, each one, r=1 . . . R, desirably has its own sample value at the reference sample point tₛₐₘₚₗₑ. Furthermore, in certain exemplary implementations, for each such synthetic sampled inverted pulse (“SSIP”) response, the sample values at the neighboring sample positions if considered left to right are the corresponding sample values taken alternatingly from inverted sampled responses with numbers r=1 . . . R. When combined, these two rules allow one to unambiguously build such synthetic responses.

At 2818, for one or more of the combined pulse responses generated (e.g., for each of the R combined pulse responses generated), candidate worst-case sequences are generated. Depending on the implementation, the worst-case sequence may be the constrained or unconstrained worst-case sequence. Any of the embodiments discussed above for generating unconstrained or constrained worst-case sequences can be used. In particular embodiments, the method of FIG. 12 is used.

At 2820, the worst-case sequence that creates the riskiest reading value is selected (e.g., the smallest value for the level “1”) from among the candidate worst-case sequences. The sequence selected can be stored on one or more computer-readable media. The sequence selected can then be used as part of a signal integrity test. When so used, it is desirable to properly position the sequence in the input stream so as to synchronize its designated sample bit (of an index nₘₐₓ) with the appropriate subinterval of the clock signal.

It should be understood that in other embodiments, the method acts of FIG. 28 are performed in a different order or concurrently with one another. Moreover, in certain embodiments, only a subset of the method acts are performed. For example, any combination or subcombination of any of the method acts can be performed with one another depending on the implementation.

B. Non-Periodical Data-Related DCD

1. Decomposition of the Input Signal into “Symmetrical”, “0 to 1”, and “1 to 0” Components

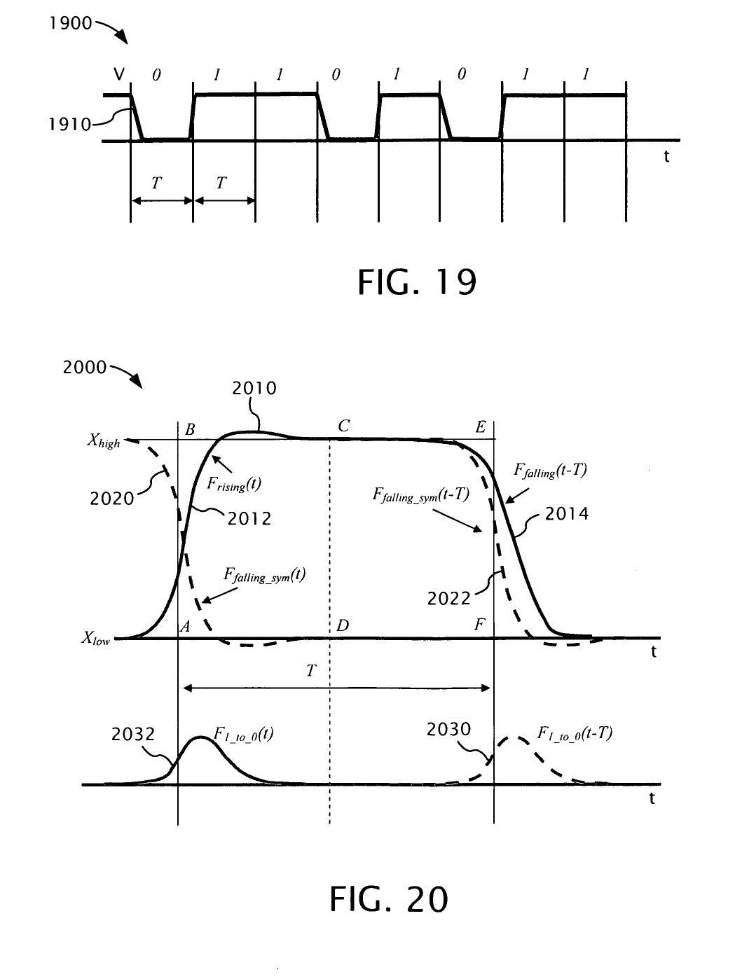

Because of a driver's pull-up and pull-down asymmetry, a channel may receive an input signal where the rising and falling transitions and the form and duration of an isolated bit “1” (as in “ . . . 00100”) and “0” (as in “ . . . 11011”) are different. Such behavior is illustrated by waveform 1910 shown in timing chart 1900 of FIG. 19.

As in the case of the clock-related DCD, the pulses may have unequal widths and the entire signal may contain nonzero DC components. However, there is no periodicity here unless the input stream consists of periodically repeating patterns. Further, asymmetry of the transitions prevents one from using a convolution to find the channel's response to a given input stream, even if the responses to individual rising or falling transitions are known.

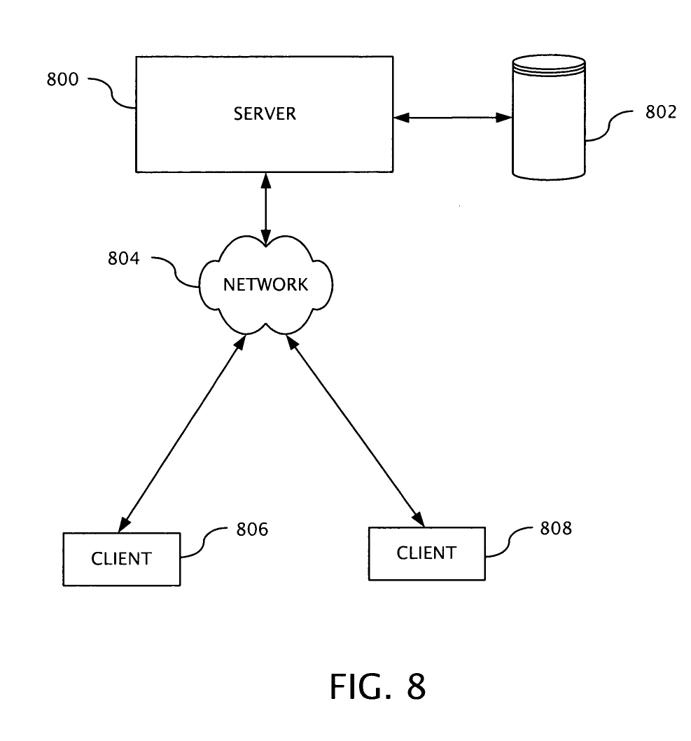

To allow a certain kind of convolution, and in one exemplary embodiment of the disclosed technology, the “original” isolated pulse can be decomposed into a “symmetrical” or “regular” component and an additional transitive component referred to as the “asymmetrical” or “irregular” component. For example, consider exemplary isolated bit-long pulse 2010 shown in graph 2000 of FIG. 20. The exemplary isolated bit-long pulse 2010 comprises a rising transition 2012 and a falling transition 2014. For simplicity, it can be assumed that the rising/falling transitions are short enough (e.g., shorter than the bit interval) to allow for an isolated “1” or “0” value bit to stabilize its level at the pulse center (e.g., the level X_{high} at point C in FIG. 8). This is a valid assumption if one considers the driver's output with no pre-emphasis. A minor modification may be used for longer transitions of the pre-emphasized driver output, where the “rising” transition is desirably considered for the combination “ . . . 0001111111 . . . ”, not for an isolated bit while the “falling” transition should be taken from “ . . . 11100000 . . . ”. For purposes of this discussion, the steady state level high and low are denoted by X_{high} and X_{low}, respectively.

One can separate the “symmetric” part of the pulse in different ways. For illustrative purposes, however, just one separation will be considered. For a given rising transition F_{rising}(t), measured with respect to level “low”, it is possible to form its vertically flipped copy, shown by dashed falling transition 2020, as:

F_{falling}_{_{—}}_{sym}(t)=X_{high}−F_{rising}(t). (17)

Then, by shifting this transition by the bit interval T, the symmetric falling transition can be obtained (shown by dashed falling transition 2022):

F_{falling}_{_{—}}_{sym}(t−T)=X_{high}−F_{rising}(t−T). (18)

This transition can be termed “symmetric,” “regular,” or “complementary” because if summed up with the rising transition of the next bit pulse, F_{rising}(t−T), it would produce a stable level X_{high}. This is what one would expect from having two or more bits “1” in a row.

The difference between the “actual” falling transition (asymmetric falling transition 2014) and F_{falling}_{_{—}}_{sym}(t−T) (symmetric falling transition 2022), the measure of “asymmetry”, is shown in the bottom of FIG. 20 as dashed waveform 2030 and can be found as follows:

F₁_{_{—}}ₜₒ_{_{—}}₀(t−T)=F_{falling}(t−T)−F_{falling}_{_{—}}_{sym}(t−T). (19)

This “asymmetric” or “irregular” component can be shifted to the left to get the function F₁_{_{—}}ₜₒ_{_{—}}₀(t), shown as solid waveform 2032.

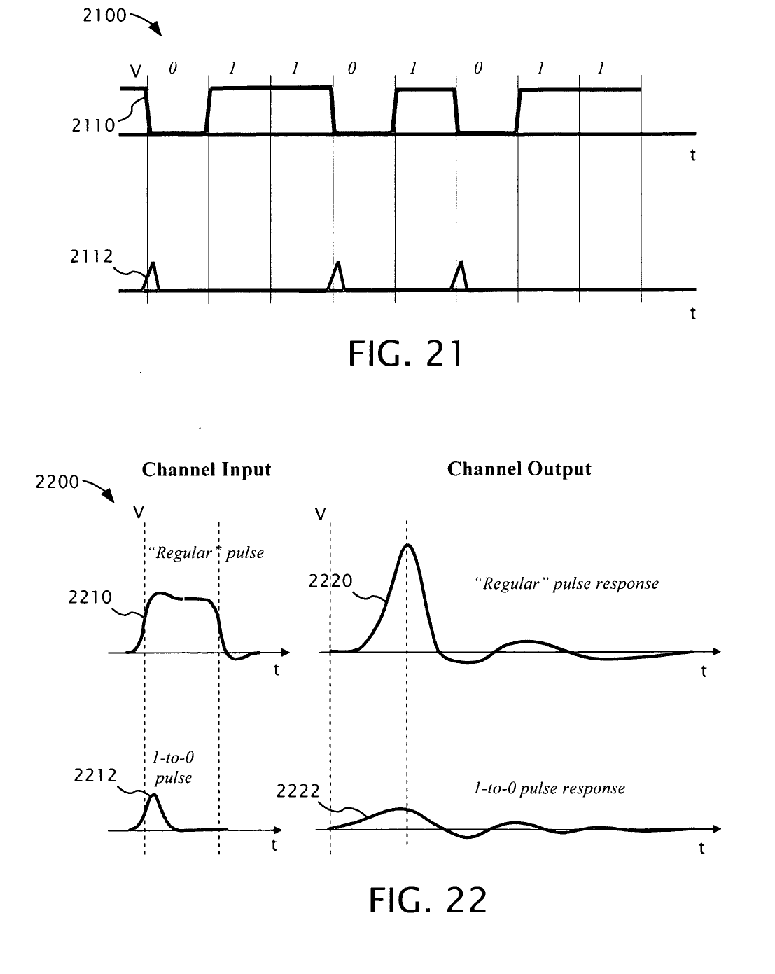

Now, returning to the original input of FIG. 19, one can view the input as a combination of a signal composed from properly delayed “symmetric” transitions F_{rising}(t), F_{falling}_{_{—}}_{sym}(t), plus the asymmetric component, consisting of the properly delayed asymmetric transition F₁_{_{—}}ₜₒ_{_{—}}₀(t), appearing only when “1” is changing to “0”. FIG. 21 is a timing chart 2100 showing the “symmetric” component 2110 of the driver's signal from FIG. 19 while the additional “asymmetric” component 2112 is shown in the lower part of the timing chart.

As noted above, the ways of separating the “symmetric” component can be different. For example, the falling edge can be used as a basis for it and additions can be built only for 0-to-1, not 1-to-0, transitions. Or, it is also possible to build other types of symmetric transitions by means of any function satisfying expression (17) and making the asymptotic remainder consist of both 0-to-1 and 1-to-0 transitions. These modifications will lead to other particular implementations of the method that can be readily derived by one of ordinary skill in the art.

The purpose of dividing the signal into its “symmetric” and “asymmetric” parts is to allow further consideration in frames of linearity and time invariance applied to the symmetric component, as well as to the asymmetric component, now consisting of separate pulses.

2. Building Inverted Sampled Responses

Now, as the above signal is applied to a linear channel, the output can be characterized by the combination of pulse responses of the symmetric (or “regular”) input component (taken for all bits of level “1”), and the pulse responses of the asymmetric (or “irregular”) transitive component, taken if the current bit “0” follows a previous bit “1”. In general, the symmetric (or regular) input component is linear and time invariant, whereas the asymmetric (or irregular) component is not.

FIG. 22 includes timing charts 2200 showing an exemplary regular pulse 2210 (based on the pulse 2012 with the symmetric falling transition 2022 shown in FIG. 20) and a 1-to-0 pulse 2212 (based on the asymmetric addition 2112), and their respective pulse responses 2220 and 2222 (computed in any of the manners explained above). When computing the responses, the relative delays of the pulses applied to a linear channel are desirably kept as in FIG. 19 and FIG. 22.

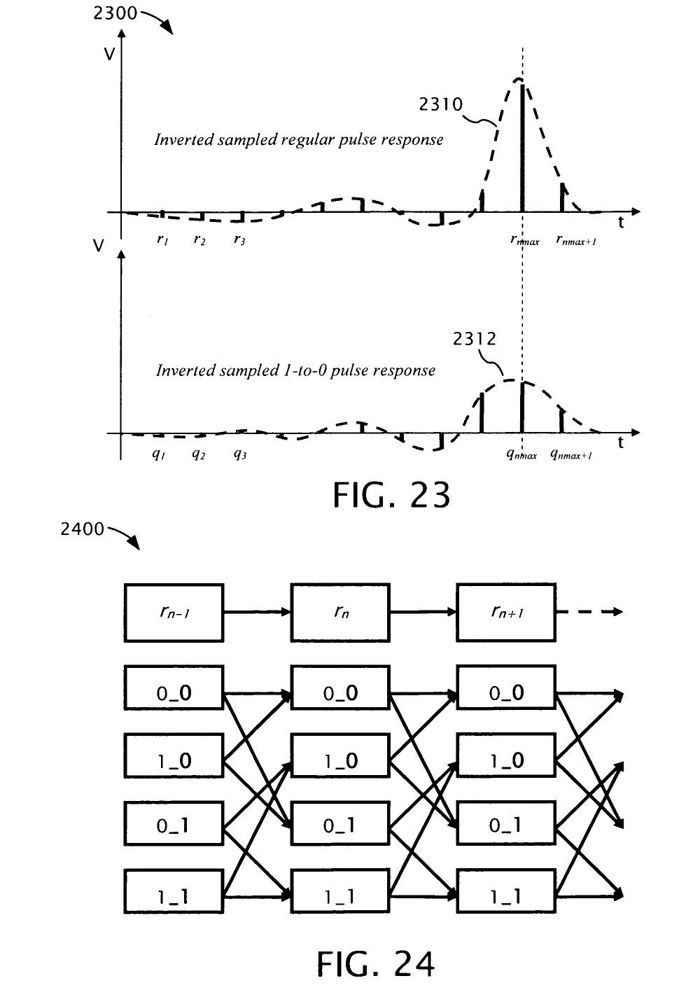

Now, as was described for the embodiment concerning clock-related DCD, for a given sample (observation) point, the inversed sampled responses can be built from the responses shown in FIG. 22. FIG. 23 is a timing chart 2300 showing the resulting inverted sampled regular pulse response 2310 corresponding to regular pulse response 2220, and the resulting inverted sampled 1-to-0 pulse response 2312 corresponding to 1-to-0 pulse response 2222. In other embodiments, noninverted sampled pulse responses are generated.

3. Building the Worst Case Sequences

In certain exemplary embodiments of the disclosed technology, the problem of building the worst case sequence can be reduced to the following: Given the sampled values at sample positions rₙ, qₙ, n=1 . . . N, as shown in FIG. 23, find a combination of coefficients αₙ that minimizes or maximizes the sum:

$$y ( {t}_{sample} ) = {\sum }_{n = 1}^{N} {α}_{n} {r}_{n} + {\sum }_{n = 1}^{N} {β}_{n} {q}_{n} , \qquad ( 20 )$$

depending on whether one wants to find the sequence that makes the worst reading for a target bit having a value “1” or “0”. Hence, in certain implementations, the procedure is performed twice and the worst possibility from among the two results selected.

In Expression (20), the coefficients are desirably selected from αₙ ε{−1,1}, except for α_{n max} which is fixed to “1” or “0” depending on the above target bit value. In one exemplary embodiment, the coefficients βₙ in the second sum depend on αₙ as follows:

$${β}_{n} = \{ \begin{matrix}1 , & only if ( {α}_{n - 1} = 1 ) ⋂ ( {α}_{n} = - 1 ) \\ 0 & otherwise\end{matrix} . \qquad ( 21 )$$

As before, the value αₙ=+1 can be selected for the bit with logical “1” and αₙ=−1 can be selected for logical “0”.

4. Building the Unconstrained Worst Case Sequence

Since the coefficients αₙ in Expressions (20), (21) cannot be selected independently for each bit, it is desirable to build a chart (or other appropriate data structure, model, or representation) that shows possible bit types and transitions from bit to bit. This exemplary approach is similar to the approach described above with respect to FIGS. 4-7, except that for the unconstrained sequence, each placeholder (in one embodiment) contains just a single bit. Possible bit types in this embodiment are: “0 preceded by 0.”, “0 preceded by 1”, “1 preceded by 0” and “1 preceded by 1”, as shown in Table 5 and Table 6.

TABLE 5
Possible bit types, predecessors and costs
(worst case when reading bit “1”)

| | | | | Cost | |
|---|---|---|---|---|---|
| | Desig- | | Cost | (n = | Possible |
| Bit types | nation | αₙ/βₙ | (n ≠ nmax) | nmax) | predecessors |
| 0 preceded by 0 | 0_0 | −1/0 | −rₙ | infinity | 0_0, 1_0 |
| 0 preceded by 1 | 1_0 | −1/1 | −rₙ + qₙ | infinity | 0_1, 1_1 |
| 1 preceded by 0 | 0_1 | 1/0 | rₙ | rₙ | 0_0, 1_0 |
| 1 preceded by 1 | 1_1 | 1/0 | rₙ | rₙ | 0_1, 1_1 |

TABLE 6
Possible bit types, predecessors and costs
(worst case when reading bit “0”)

| | | | | Cost | |
|---|---|---|---|---|---|
| | Desig- | | Cost | (n = | Possible |
| Bit types | nation | αₙ/βₙ | (n ≠ nmax) | nmax) | predecessors |
| 0 preceded by 0 | 0_0 | −1/0 | −rₙ | −rₙ | 0_0, 1_0 |
| 0 preceded by 1 | 1_0 | −1/1 | −rₙ + qₙ | −rₙ + qₙ | 0_1, 1_1 |
| 1 preceded by 0 | 0_1 | 1/0 | rₙ | Minus | 0_0, 1_0 |
| | | | | infinity | |
| 1 preceded by 1 | 1_1 | 1/0 | rₙ | Minus | 0_1, 1_1 |
| | | | | infinity | |

In one exemplary embodiment, the cost of a particular bit type is the contribution the bit makes into y(tₛₐₘₚₗₑ) in Expression (20). The “infinity” (or “minus infinity”) value is introduced to exclude the choice of zero (or one) bit at the reference sample position. Practically, the cost value should just be large enough to prevent its selection. Of note in Tables 5 and 6 are the costs for the “0 preceded by 1” bit type (which correspond to a 1-to-0 or falling transition). Because falling transitions have a different duration in this example due to the data-dependent DCD, the costs shown in Tables 5 and 6 for such transitions are based on a sample from the symmetrical pulse response and a sample from the additional pulse response representing the asymmetrical component (−rₙ+qₙ). It should be noted that the particular costs shown in Tables 5 and 6 are examples only and that other values may be used depending on the implementations.

Possible transitions between different bit types are shown in block diagram 2400 of FIG. 24. (Note that FIG. 24 is similar to FIG. 4 above.) Using Tables 5 and 6 and the chart of FIG. 24, an exemplary technique for finding the coefficients minimizing Expression (11) can be formulated.

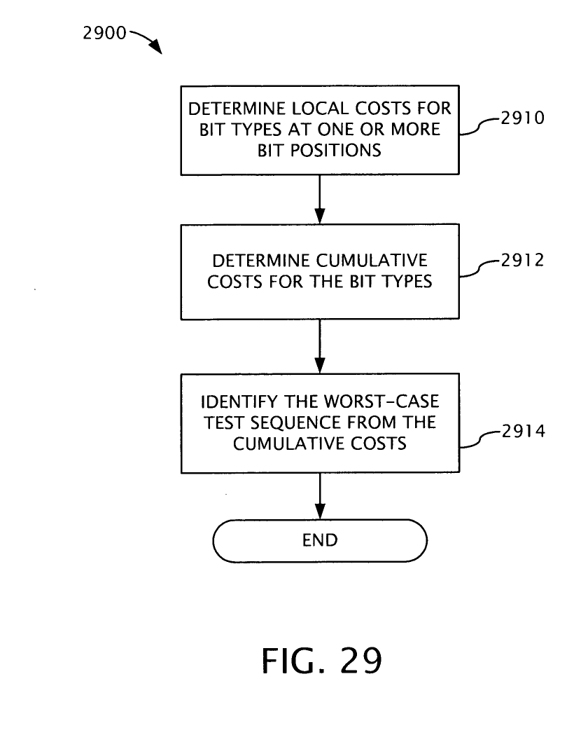

FIG. 29 is a flowchart 2900 illustrating one exemplary embodiment for generating a worst-case sequence for linear channels that experience non-periodical data-related DCD. The exemplary method can be applied to inverted or noninverted sampled responses determined in the manner described above so that the sampled values of rₙ and qₙ are known.

At 2910, for one or more bit positions or placeholders (e.g., for each bit position or placeholder (n=1 . . . N)), and for one or more bit types (e.g., for each bit type), a corresponding cost is found. For example, the costs can be determined using the values shown in Tables 5 and 6.

At 2912, for one or more bit types in one or more positions (e.g., for every bit type in every position), a “cumulative” cost is established and a desirable predecessor is identified. For example, in one exemplary embodiment, a sweep is performed (e.g., from left to right, right to left, or in other manners). In one exemplary embodiment, for the first bit position (e.g., the leftmost bit), the cumulative cost of each bit type is its own cost (e.g., found in the above method act). For the next positions, n=2 . . . N, the cumulative cost of every bit can be defined as a sum of its own cost plus the smallest (or largest, depending on the target bit value) cumulative cost from its available predecessors. At this point, the bit holder can store its predecessor (or a pointer to it) with the smallest (or largest, depending on the target bit value) cumulative cost by marking it as the preferred predecessor. Conceptually, the cumulative cost for a respective bit type indicates how effective a series of bits comprising the respective bit type together with the selected predecessor bit types is at altering the intended output of a circuit channel.

At 2914, the worst sequence is identified from the resulting cumulative costs. For example, once the sweep is completed, the elements in the last position will contain cumulative costs that are “global.” From the alternatives, the one with the smallest (or largest, depending on the target bit value) cost can be selected. This element will belong to the chain constituting the worst sequence. Now, since predecessors of the placeholders have been marked, it is possible to restore the chain that led to the desired solution. In one exemplary embodiment, the restored chain is selected and stored as the worst case sequence because the bit type (as shown in Tables 5 and 6) can be directly associated with the coefficients αₙ.

It should be understood that in other embodiments, the method acts of FIG. 29 are performed in a different order or concurrently with one another. Moreover, in certain embodiments, only a subset of the method acts are performed. For example, any combination or subcombination of any of the method acts can be performed with one another depending on the implementation.

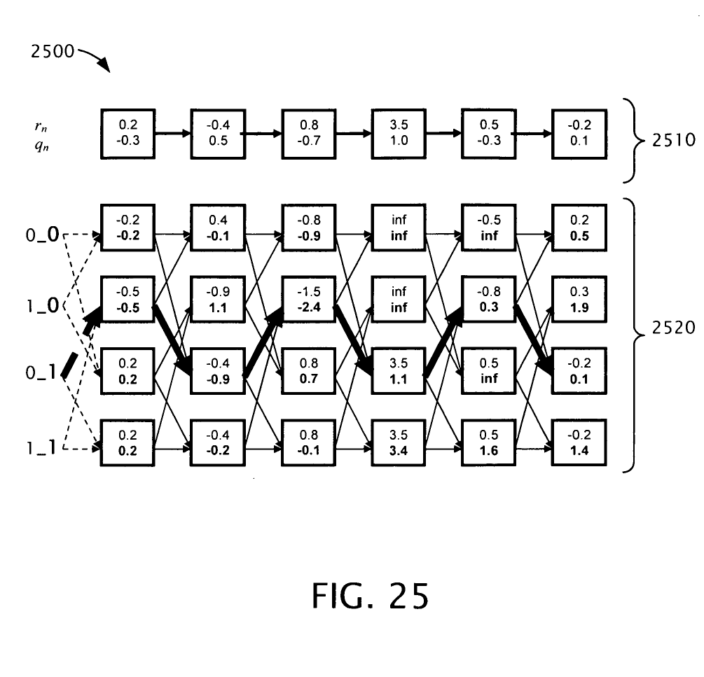

An implementation of the above-described technique is illustrated in block diagram 2500 of FIG. 25, where the worst sequence minimizing the reading for bit value “1” is found. The boxes along the top of block diagram 2500 (boxes 2510) contain the sample values of the sample positions from the symmetric inverted sampled pulse response (rₙ) and the additional inverted sampled pulse response representing the asymmetric component (qₙ). The top values in each of the main boxes 2520 are local costs (computed using the values shown in Table 5) for each of the bit types. The bottom values in the main boxes 2520 (in bold) are cumulative costs. They are found as in method act 2912. It can be seen that the rightmost bit that demonstrates the smallest cumulative cost (here, “0.1”) is a “one after zero” type. From there, the path (shown in bold arrows) that led to this bit type/position can be restored. The resulting worst case sequence for this example, therefore, is “1-010101”. Here, the first separated bit “1” is just an indication that the pre-existing state should be “1” as the leftmost element desirably belongs to the optimal chain.

5. Building the Worst Case Sequence Constrained by the 8b10b Protocol

To build the sequence constrained by the 8b10b protocol, the techniques described above with respect to FIGS. 4-7 and 12 can be used with some modifications as described below (e.g., some additional method acts are used to account for the presence of the “asymmetric” 1-to-0 or 0-to-1 transitions).

Table 3 above defined possible 6- or 4-bit groups having different disparities. When data-related DCD exists in the input signal, it is desirable to further account for transitions that bring in “asymmetry” or “irregularity.” For illustrative purposes, consider a transition that is from bit “1” to bit “0” (although the exemplary techniques can be modified to use a reverse transition).

According to one exemplary embodiment, the possible combinations of bits in each group are further separated by considering the value of a bit that directly precedes the group and the last bit value in this group. That is, in this embodiment, groups with end bits of “0” or “1” are desirably distinguished. In this manner, one will be able not only to properly account for 1-to-0 transitions inside each group, but also to take care of such transitions if they happen “between” the groups. For example, the group nP6p may be split into 4 subgroups:

(1) 0_nP6p-0 → last bit in preceding group was “0”, last bit in this group is “0”;

(2) 0_nP6p-1 → last bit in preceding group was “0”, last bit in this group is “1”;

(3) 1_nP6p-0 → last bit in preceding group was “1”, last bit in this group is “0”;

(4) 1_nP6p-1 → last bit in preceding group was “1”, last bit in this group is “1”

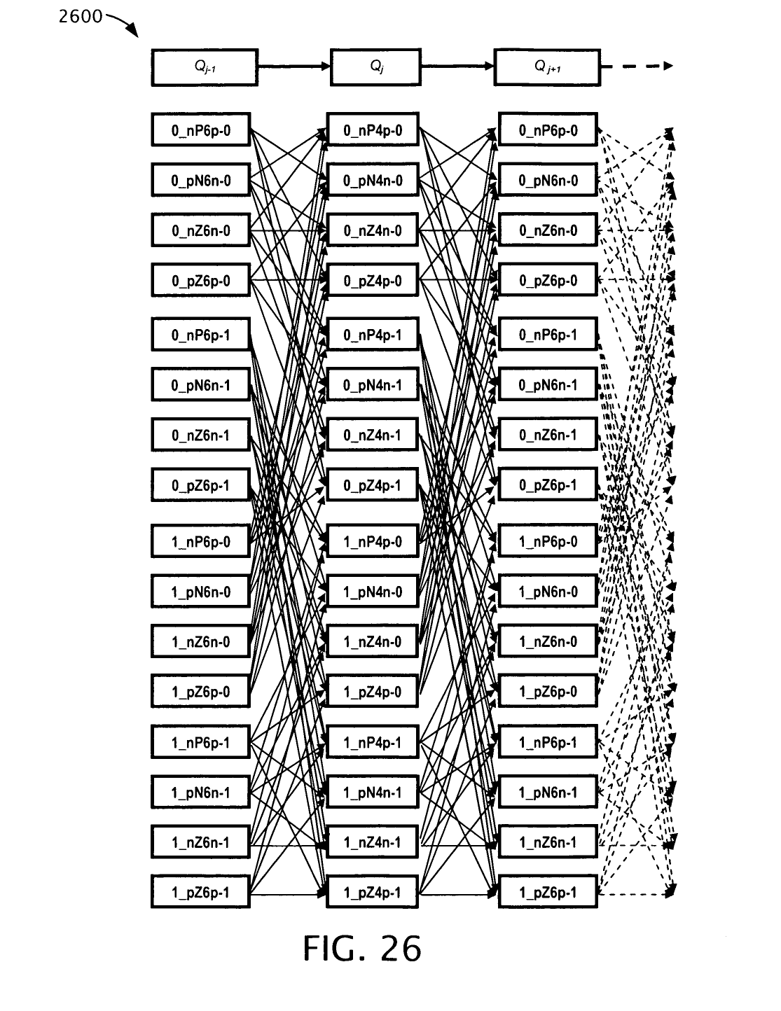

Note that Table 7 below does not indicate bits preceding each group. In many cases, each group of Table 7 may have different preceding bits. This can be accounted for, for example, in the manner described below with respect to FIG. 26.

TABLE 7
8b10b code groups of different word types and with 0 or 1 ending bits

| nP6p | pN6n | nZ6n | pZ6p | nP4p | pN4n | nZ4n | pZ4p |
|---|---|---|---|---|---|---|---|
| ‘_0’ | ‘_0’ | ‘_0’ | ‘_0’ | ‘_0’ | ‘_0’ | ‘_0’ | ‘_0’ |
| 111010 | 100100 | 110100 | 110100 | 1110 | 0100 | 1010 | 1001 |
| 110110 | 110000 | 101100 | 101100 | | 0010 | 0110 | 0101 |
| 101110 | 010100 | 011100 | 011100 | ‘_1’ | 1000 | 1100 | 0011 |
| 011110 | 011000 | 110010 | 110010 | 1011 | | | |
| | 100010 | 101010 | 101010 | 1101 | ‘_1’ | ‘_1’ | ‘_1’ |
| ‘_1’ | 010010 | 011010 | 011010 | 0111 | 0001 | 1001 | 1010 |
| 011011 | 001010 | 100110 | 100110 | | | 0101 | 0110 |
| 001111 | 000110 | 010110 | 010110 | | | | |
| 101011 | 101000 | 001110 | 001110 | | | | |
| 100111 | 001100 | 111000 | | | | | |
| 011101 | | | ‘_1’ | | | | |
| 101101 | ‘_1’ | ‘_1’ | 110001 | | | | |
| 110101 | 000101 | 110001 | 101001 | | | | |
| 111001 | 001001 | 101001 | 011001 | | | | |
| 010111 | 010001 | 011001 | 100101 | | | | |
| 110011 | 100001 | 100101 | 010101 | | | | |
| | | 010101 | 001101 | | | | |
| | | 001101 | 100011 | | | | |
| | | 100011 | 010011 | | | | |
| | | 010011 | 001011 | | | | |
| | | 001011 | 000111 | | | | |

For each sub-group, and according to certain exemplary embodiments of the disclosed technology, separate methods are used to calculate the local cost of the group and to determine the connection to the available type of the next group. In total, there will be 4×4=16 group types for each bit group position in this example, as illustrated by FIG. 26. The group of each type has 4 ancestors and 4 predecessors, as dictated by selections between “_{—}0”/“_{—}1” and “p”/“n”.

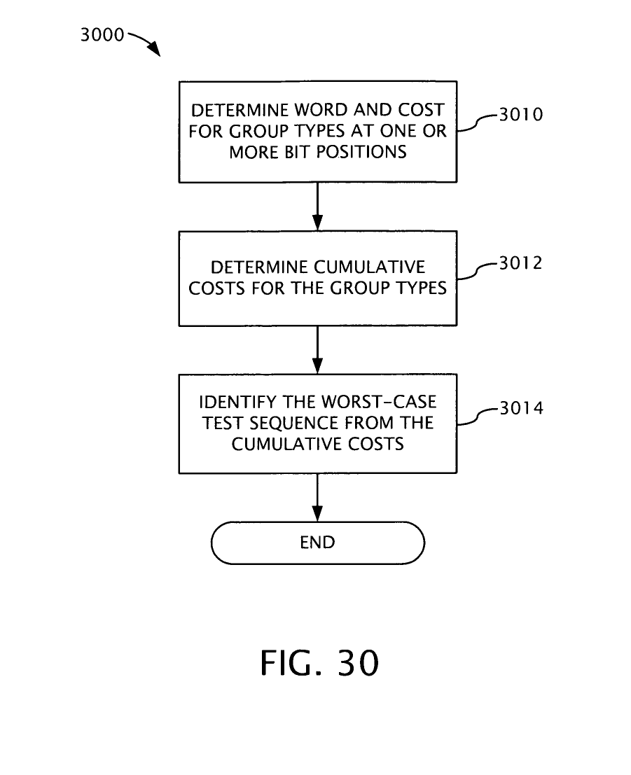

FIG. 30 is a flowchart 3000 illustrating one exemplary method for generating an 8b10b worst case sequence for a linear channel that experiences data-related DCD. The exemplary method can be applied to inverted sampled responses determined in the manner described above so that the sample values of the sample positions rₙ and qₙ are known.

At method act 3010, a word and cost for one or more group types in one or more bit group positions are determined. For instance, in one particularly desirable implementation, the optimum word and cost in each bit group position is found for each group type. This determination can be made, for example, by selecting from Table 7 the optimal word for each type. The value obtained is termed a local cost corresponding to a certain position and group type and will typically be the smallest (or largest) local cost possible for a given group type and bit group position.

At method act 3012, a “cumulative” cost and a desired predecessor is determined for one or more group types in one or more positions (placeholders). For instance, in one particularly desirable implementation, a cumulative cost and optimal predecessor is determined for every group type in every position. To perform this method act, for example, a sweep can be performed (e.g., from left to right, right to left, or in other manners). In one exemplary embodiment, for the first group position (e.g. leftmost), the cumulative cost of each group type is its own cost (found in the method act 3010). For the next positions, the cumulative cost of each group can be defined as a sum of its own local cost plus the smallest (or largest) cumulative cost from its available predecessors. At this point, the group holder stores the predecessor (or a pointer to it) with the smallest or largest cumulative cost by marking it as the most desirable predecessor. Conceptually, the cumulative cost for a respective group type indicates how effective a series of bits comprising the respective group type together with the selected predecessor group types is at altering the intended output of a circuit channel.

At method act 3014, the worst sequence is identified from the resulting cumulative costs. In particular, once the sweep is completed, the elements in the last position will contain cumulative costs that are “global.” From the available alternatives (e.g., 16 alternatives), one can find the element with the smallest (or largest) cost. This element will belong to the chain constituting the worst sequence. Now, since the predecessors of each placeholder have been marked, it is possible to restore the chain that led to this solution. The restored chain can be identified and stored as the worst case sequence.

At method act 3016, the above-recited method acts are repeated for one or more additional starting positions (e.g., for all possible (for instance, 10)) group starting positions). This allows one to find the globally optimal solution.

At method act 3018, the four above-recited method acts are repeated as necessary in order to determine both the smallest total cost (e.g., so that the worst case sequence that minimizes the reading of the bit with value “1” is searched for and identified) and the largest total cost (e.g., so that the worst case sequence that maximizes the reading for bit “0” is searched for and identified). Thus, in these embodiments, the word “optimal” is used to refer to both the “smallest” and “largest” depending on which worst case sequence is being determined.

It should be understood that in other embodiments, the method acts of FIG. 30 are performed in a different order or concurrently with one another. Moreover, in certain embodiments, only a subset of the method acts are performed. For example, any combination or subcombination of any of the method acts can be performed with one another depending on the implementation.

The following paragraphs describe particular embodiments for implementing method act 3010 from FIG. 30. In general, the optimal word of a certain type can be selected during this method act (e.g., from Table 7). For example, assume that the word type is 1_pz6p_{—}0, it does not contain a “leading bit position,” and optimality means getting the smallest cost (e.g., reading the bit value “1”). Because the end bit in this group is “_{—}0”, only the upper portion of the column “pz6p” in Table 7 is considered. Also, for each individual bit of each 6-bit group, the local cost can be found from Table 5. As before (in the cases of unconstrained sequences), one can assume that the samples of the inverted regular and 1-to-0 pulse responses are known and already assigned, from left to right, to every bit of each group shown in FIG. 26. In other words, when one considers a particular group position Qⱼ in FIG. 26, its corresponding sample values rⱼₖ, qⱼₖ, k=1 . . . 4 or 6 are known.

The pseudocode shown in Table 8 illustrates one exemplary embodiment for implementing method act 3010 assuming the word type is “pz6p” and should not be construed as limiting in any way:

TABLE 8
Exemplary pseudocode for determining
the local optimum in one or more positions

```
optimal_local_cost = 1e99; (large number)
For each of “pz6p_0” code words of Table 7:
{
        local_cost = 0;
        For each bit k=1...6 of the selected code word,
        {
              Take cursor values rⱼₖ, qⱼₖ;
              Find bit cost (bit_cost) from Table 7.
                      Here, for k>1, the value of
                      the preceding bit it is known.
                      For k=1, the preceding bit value
                      is ‘1’ (because the word
                      type 1_pz6p_0 is considered)
              local_cost = local_cost + bit_cost;
        }
        if local_cost < optimal_local_cost
        {
              optimal_local_cost = local_cost;
              optimal_code_word = current code word;
        }
}
```

With modifications (e.g., code word type, number of bits (6 or 4), cursor values, preceding bit value), this exemplary approach can be directly applied to other code words. Further, when searching for the worst case sequence maximizing the bit “0” reading, and in one exemplary embodiment, a large negative initial value for the optimal local cost is selected, Table 6 instead of Table 5 is used, and the sign of inequality when comparing the current local cost and the optimal local cost is changed.

If the word contains the leading bit position, one can either use the cost value shown in Table 5 or 6 for this bit, or simply skip the word if this bit value does not correspond to the target reading value. For example, when finding the worst case pattern minimizing the reading for bit value “1”, one can skip all the words where the bit value in the leading bit position is “0”.

### IV. Exemplary Computing Environments

Any of the aspects of the technology described above may be performed using a distributed computer network. FIG. 8 shows one suitable exemplary network. A server computer 800 can have an associated storage device 802 (internal or external to the server computer). For example, the server computer 800 can be configured to generate test sequences using any of the disclosed methods (e.g., as part of an EDA software tool, such as a signal integrity analysis tool). The server computer 800 can be coupled to a network, shown generally at 804, which can comprise, for example, a wide-area network, a local-area network, a client-server network, the Internet, or other suitable network. One or more client computers, such as those shown at 806, 808, may be coupled to the network 804 using a network protocol. The work may also be performed on a single, dedicated workstation, which has its own memory and one or more CPUs.

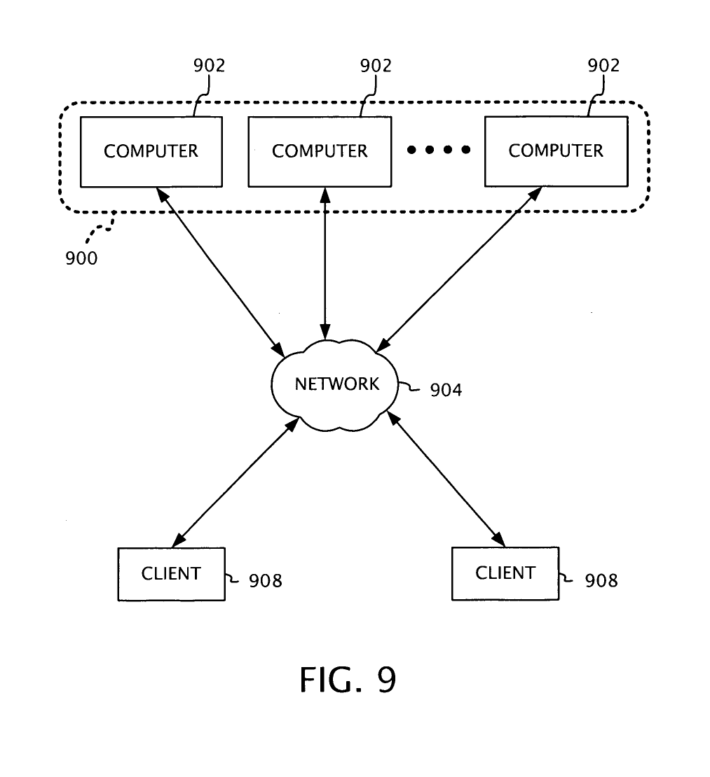

FIG. 9 shows another exemplary network. One or more computers 902 communicate via a network 904 and form a computing environment 900 (e.g., a distributed computing environment). Each of the computers 902 in the computing environment 900 can be used to perform at least a portion of the sequence generating process. The network 904 in the illustrated embodiment is also coupled to one or more client computers 908.

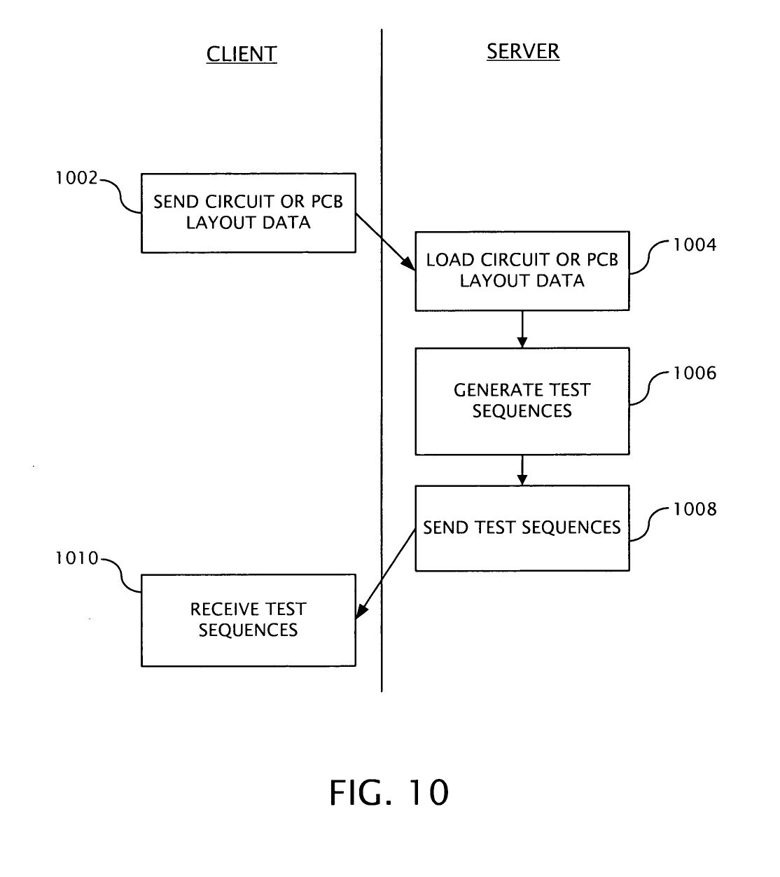

FIG. 10 shows that design information for a circuit or PCB design (e.g., a PCB layout file (such as a .HYP file), an HDL file, netlist, GDSII file, Oasis file, or other suitable design file representing the circuit- or PCB-under-test) can be analyzed using a remote server computer (such as the server computer 800 shown in FIG. 8) or a remote computing environment (such as the computing environment 900 shown in FIG. 9) in order to generate a test sequence according to any of the disclosed embodiments. At process block 1002, for example, the client computer sends the design information to the remote server or computing environment. In process block 1004, the design information is received and loaded by the remote server or by respective components of the remote computing environment. In process block 1006, test sequence generation is performed according to any of the disclosed embodiments. At process block 1008, the remote server or computing environment sends the resulting test sequences to the client computer, which receives the data at process block 1010.

It should be apparent to those skilled in the art that the example shown in FIG. 1000 is not the only way to generate test sequences using multiple computers. For instance, the circuit or PCB design information may be stored on a computer-readable medium that is not on a network and that is sent separately to the server or computing environment (e.g., a CD-ROM, DVD, or portable hard drive). Or, the server computer or remote computing environment may perform only a portion of the test sequence generation procedure.

Having illustrated and described the principles of the disclosed technology, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only preferred examples of the technologies and should not be taken as limiting the scope of the invention. Rather, the scope of the invention is defined by the following claims and their equivalents. I therefore claim as my invention all that comes within the scope and spirit of these claims.

What is claimed is:

1. One or more computer-readable media storing computer-executable instructions for causing a computer to perform a method, the method comprising:
dividing a period of an input signal into two or more subintervals, each subinterval having a duration that is different from other subintervals;
generating pulse representations for each of the subintervals, the pulse representations representing pulse durations corresponding to the respective durations of each of the subintervals;
generating sampled pulse responses to the pulse representations;
combining samples from two or more of the sampled pulse responses to create one or more combined sampled pulse responses;
determining a test sequence for testing the electrical behavior of a circuit channel using the one or more combined sampled pulse responses; and
storing the test sequence.

2. The one or more computer-readable media of claim 1, wherein the combined sampled pulse responses comprise sample values alternatingly selected from the sampled pulse responses.

3. The one or more computer-readable media of claim 1, wherein the period of the input signal is divided into a first subinterval and a second subinterval, the first subinterval corresponding to even bits in the input signal and the second subinterval corresponding to odd bits in the input signal, and wherein the sampled pulse responses comprise a first sampled pulse response corresponding to the even bits in the input signal and a second sampled pulse response corresponding to the odd bits in the input signal.

4. The one or more computer-readable media of claim 3, wherein the one or more combined sampled pulse responses comprise a first combined sampled pulse response and a second combined sampled pulse response, the first combined sampled pulse response comprising alternating samples from the first and the second sampled pulse responses and having a largest sample value selected from the first sampled pulse response, the second combined sampled pulse response comprising alternating samples from the first and the second sampled pulse responses and having a largest sample value selected from the second sampled pulse response.

5. The one or more computer-readable media of claim 1, wherein two or more combined sampled pulse responses are generated and wherein the act of determining a test sequence comprises:
determining a candidate test sequence for each of the two or more combined sampled pulse responses; and
selecting the test sequence from among the candidate test sequences, the test sequence selected being the test sequence that creates the smallest eye opening in an eye diagram.

6. The one or more computer-readable media of claim 1, wherein the differences in the durations of the two or more subintervals are a result of clock-related duty-cycle distortion.

7. The one or more computer-readable media of claim 1, wherein the sampled pulse responses are inverted sampled pulse responses.

8. The one or more computer-readable media of claim 1, wherein the test sequence generated complies with a transmission code.

9. The one or more computer-readable media of claim 8, wherein the transmission code is a 8b10b code.

10. The one or more computer-readable media of claim 1, wherein the act of determining a test sequence comprises:
for each respective one of the one or more combined sampled pulse responses,
dividing the respective combined sampled pulse response into a series of bit groups, the respective lengths of the bit groups in the series complying with a transmission code;
determining possible code word types corresponding to the bit groups of the respective combined sampled pulse response, the possible code word types also complying with the transmission code;
computing cumulative costs for one or more of the possible code word types, the cumulative cost for a respective code word type indicating how effective a sequence comprising a code word of the respective code word type together with one or more other code words is at altering the intended output of a circuit channel when the sequence is included in the test sequence; and
generating the test sequence by selecting a sequence of code words based at least in part on the determined cumulative costs.

11. The one or more computer-readable media of claim 10, wherein the act of determining a test sequence further comprises, for each respective one of the one or more combined sampled pulse responses, computing local costs for the one or more of the possible code word types, the local cost for a respective code word type indicating how effective a code word of the respective code word type is at altering an intended output of the circuit channel when the code word is included in the test sequence.

12. One or more computer-readable media storing computer-executable instructions for causing a computer to perform a method, the method comprising:
decomposing an asymmetrical input pulse into a symmetrical component and an asymmetrical component;
generating a first sampled pulse response to the symmetrical component;
generating a second sampled pulse response to the asymmetrical component;
determining a test sequence for testing the electrical behavior of a circuit channel using the first sampled pulse response and the second sampled pulse response; and
storing the test sequence.

13. The one or more computer-readable media of claim 12, wherein the asymmetry in the asymmetrical input pulse is caused by data-dependent duty-cycle distortion.

14. The one or more computer-readable media of claim 12, wherein the symmetrical component is linear and time invariant, and wherein the asymmetrical component is not linear and time invariant.

15. The one or more computer-readable media of claim 12, wherein the test sequence generated complies with a transmission code.

16. The one or more computer-readable media of claim 15, wherein the transmission code is the 8b10b transmission code.

17. The one or more computer-readable media of claim 12, wherein the first sampled pulse response and the second sampled pulse response are inverted sampled pulse responses.

18. The one or more computer-readable media of claim 12, wherein the act of generating the first sampled pulse response to the symmetrical component and the second sampled pulse response to the asymmetrical component comprises:
simulating application of the symmetrical component to a circuit channel, thereby generating a first pulse response;
dividing the first pulse response into first pulse samples, thereby generating the first sampled pulse response;
simulating application of the asymmetrical component to the circuit channel, thereby generating a second pulse response; and
dividing the second pulse response into second pulse samples, thereby generating the second sampled pulse response,
the first pulse samples and the second pulse samples being determined according to the bit rate at which the circuit channel is to operate.

19. The one or more computer-readable media of claim 12, wherein the test sequence minimizes an eye opening of an eye diagram that displays a representation of the circuit channel's response to the test sequence.

20. One or more computer-readable media storing computer-executable instructions for causing a computer to perform a method, the method comprising:
decomposing an asymmetrical input pulse into a symmetrical component and an asymmetrical component;
generating a first sampled pulse response to the symmetrical component;
generating a second sampled pulse response to the asymmetrical component;
dividing the first sampled pulse response and the second sampled pulse response into a series of bit positions;
determining bit types that can be included at each of the bit positions;
computing cumulative costs for one or more of the bit types at a respective bit position using both the first sampled pulse response and the second sampled pulse response, the cumulative cost for a respective bit type indicating how effective a series of bits comprising the respective bit type together with one or more bit types at other bit positions is at altering the intended output of a circuit channel; and
determining a test sequence by selecting bit types for each of the bit positions based at least in part on the computed cumulative costs.

21. The one or more computer-readable media of claim 20, wherein the asymmetry in the asymmetrical input pulse is caused by data-dependent duty-cycle distortion.

22. The one or more computer-readable media of claim 20, wherein the act of determining the test sequence further comprises computing local costs for the one or more of the bit types at the respective bit position, the local cost for a respective bit type indicating how effective the respective bit type is at altering the intended output of the circuit channel.

23. The one or more computer-readable media of claim 22, wherein the local cost for a respective bit type is based at least in part on the value of the first sampled pulse response at the respective bit position and the value of the second sampled pulse response at the respective bit position.

24. The one or more computer-readable media of claim 20, wherein the act of computing the cumulative costs comprises computing cumulative costs of series of bits that represent full test sequences, and wherein the act of generating the test sequence comprises selecting the series of bits with the lowest cumulative cost or selecting the series of bits with the highest cumulative cost.

25. The one or more computer-readable media of claim 20, wherein the cumulative cost for the respective bit type at the respective bit position is based at least in part on a cumulative cost of a bit type at a preceding bit position, the bit type at the preceding position being one of multiple permissible bit types at the preceding bit position.

26. The one or more computer-readable media of claim 25, wherein the bit type at the preceding bit position has the lowest cumulative cost of the multiple permissible bit types at the preceding bit position or the highest cumulative cost of the multiple permissible bit types at the preceding bit position.

27. One or more computer-readable media storing computer-executable instructions for causing a computer to perform a method, the method comprising:
decomposing an asymmetrical input pulse into a symmetrical component and an asymmetrical component;
generating a first sampled pulse response to the symmetrical component;
generating a second sampled pulse response to the asymmetrical component;
dividing the first sampled pulse response and the second sampled pulse response into a series of bit groups, the respective lengths of the bit groups complying with a transmission code;
determining group types that can be used for each of the bit groups, the group types also complying with the transmission code;
computing cumulative costs for one or more of the group types for a respective bit group using both the first sampled pulse response and the second sampled pulse response, the cumulative cost for a respective group type indicating how effective a series of bits comprising a code word of the respective group type together with one or more other code words from other bit groups is at altering an intended output of a circuit channel; and
generating the test sequence by selecting code words and group types for each bit group based at least in part on the computed cumulative costs.

28. The one or more computer-readable media of claim 27, wherein the asymmetry in the asymmetrical input pulse is caused by data-dependent duty-cycle distortion.

29. The one or more computer-readable media of claim 27, wherein the act of determining the test sequence further comprises computing local costs for the one or more of the group types for the respective bit group, the local cost for a respective group type indicating how effective a code word of the respective group type is at altering the intended output of the circuit channel.

30. The one or more computer-readable media of claim 29, wherein the act of computing the local costs comprises evaluating possible code words of a respective group type to determine which of the possible code words produces the lowest local cost or the highest local cost for that respective group type.

31. The one or more computer-readable media of claim 29, wherein the local cost for a respective group type is based at least in part on the values of the first sampled pulse response corresponding to the respective bit group and the values of the second sampled pulse response corresponding to the respective bit group.

32. The one or more computer-readable media of claim 29, wherein the local cost for the respective group type depends in part on whether a transition exists at the beginning or end of the respective group type.

33. The one or more computer-readable media of claim 27, wherein the act of computing the cumulative costs comprises computing cumulative costs of series of bits that represent full test sequences, and wherein the act of generating the test sequence comprises selecting the series of bits with the lowest cumulative cost or the series of bits with the highest cumulative cost.

34. The one or more computer-readable media of claim 27, wherein the cumulative cost for a respective group type for the respective bit group is based at least in part on a cumulative cost of a group type for a preceding bit group, the group type for the preceding bit group being one of multiple permissible group types at the preceding bit group.

35. The one or more computer-readable media of claim 34, wherein the group type at the preceding bit position has a code word resulting in the lowest cumulative cost of the multiple permissible group types at the preceding bit position or resulting in the highest cumulative cost of the multiple permissible bit types at the preceding bit position.

36. The one or more computer-readable media of claim 27, wherein the act of dividing includes orienting the bit groups in a first orientation relative to a leading bit in the first and second sampled pulse response, the method further comprising repeating the acts of dividing, determining, and computing for one or more other bit group orientations relative to the leading bit.

37. The one or more computer-readable media of claim 27, wherein the transmission code is the 8b10b transmission code.
